(19) United States
(12) Patent Application Publication
(10) Pub. No.: US 2017/0227871 A1
(43) Pub. Date: Aug. 10, 2017

(54) IMAGE FORMING APPARATUS, ELECTROSTATIC CHARGE IMAGE DEVELOPER, AND ELECTROSTATIC CHARGE IMAGE DEVELOPING TONER

(71) Applicant: FUJI XEROX CO., LTD., Tokyo (JP)

(72) Inventors: Tomohito NAKAJIMA, Kanagawa (JP); Hiroyoshi OKUNO, Kanagawa (JP); Satoshi INOUE, Kanagawa (JP); Yoshifumi IIDA, Kanagawa (JP); Yuka ZENITANI, Kanagawa (JP); Yoshifumi ERI, Kanagawa (JP); Takeshi IWANAGA, Kanagawa (JP); Sakae TAKEUCHI, Kanagawa (JP); Yasuo KADOKURA, Kanagawa (JP); Yasuhisa MOROOKA, Kanagawa (JP); Shunsuke NOZAKI, Tokyo (JP)

(73) Assignee: FUJI XEROX CO., LTD., Tokyo (JP)

(21) Appl. No.: 15/221,166

(22) Filed: Jul. 27, 2016

(30) Foreign Application Priority Data
Feb. 10, 2016 (JP) 2016-024115

(51) Int. Cl. G03G 9/00

(52) U.S. Cl. CPC G03G 9/08755; G03G 21/0011; G03G 15/08; G03G 9/08711

(57) ABSTRACT

An image forming apparatus includes a developing unit that contains an electrostatic charge image developer and develops an electrostatic charge image formed on a surface of the image holding member with the developer, wherein the developer contains a carrier and an electrostatic charge image developing toner that includes a toner particle which contains a urea-modified polyester resin, and includes, in a vicinity of a surface thereof, vinyl resin particles; and an external additive which contains silica particles having a compression aggregation degree of 60% to 95% and a particle compression ratio of 0.20 to 0.40.

### CROSS-REFERENCE TO RELATED APPLICATIONS

This application is based on and claims priority under 35 USC 119 from Japanese Patent Application No. 2016-024115 filed Feb. 10, 2016.

### BACKGROUND

1. Technical Field

The present invention relates to an image forming apparatus, an electrostatic charge image developer, and an electrostatic charge image developing toner.

2. Related Art

A method of visualizing image information through an electrostatic charge image, such as electrophotography, is currently used in various fields. The electrophotography is a method of forming image information on a surface of an image holding member (photoreceptor) as an electrostatic charge image through a charging process and an exposure process, and visualizing the image information through a development process of visualizing a toner image on the surface of the image holding member using a developer containing a toner, a transfer process of transferring the toner image to a recording medium such as paper, and a fixing process of fixing the toner image onto a surface of the recording medium. At this time, toner particles or additives not transferred or discharge products remain on the surface of the image holding member after the transfer process has finished, and thus, a cleaning process of removing these materials before forming a next image is conventionally prepared.

As a cleaning method of removing transfer residual toner and the like, a method of removing each of them by using a fur brush or a magnetic brush or a method of using a member having a blade-shaped elastic material (cleaning blade) is used. The mechanism of the latter method of bringing an edge of a blade to contact with a surface of an image holding member, similar to wipers of a car, and collecting and scraping residual toner and the like in accordance with the rotation movement of the image holding member is normally used, from viewpoints of a simple configuration and low cost.

### SUMMARY

According to an aspect of the invention, there is provided an image forming apparatus including:

an image holding member;

a charging unit that charges a surface of the image holding member;

an electrostatic charge image forming unit that forms an electrostatic charge image on a charged surface of the image holding member;

a developing unit that contains an electrostatic charge image developer and develops the electrostatic charge image formed on the surface of the image holding member with the electrostatic charge image developer as a toner image;

a transfer unit that transfers the toner image formed on the surface of the image holding member onto a surface of a recording medium;

a cleaning unit that includes a cleaning blade that cleans the surface of the image holding member; and

a fixing unit that fixes the toner image transferred onto the surface of the recording medium,

wherein the electrostatic charge image developer contains a carrier and

an electrostatic charge image developing toner that includes a toner particle which contains a urea-modified polyester resin, and includes, in a vicinity of a surface thereof, vinyl resin particles and an external additive which contains silica particles having a compression aggregation degree of 60% to 95% and a particle compression ratio of 0.20 to 0.40.

### BRIEF DESCRIPTION OF THE DRAWINGS

Exemplary embodiments of the present invention will be described in detail based on the following figures, wherein:

FIG. 1 is a schematic configuration diagram showing an example of an image forming apparatus according to the exemplary embodiment; and

FIG. 2 is a schematic configuration diagram showing an example of a process cartridge according to the exemplary embodiment.

### DETAILED DESCRIPTION

Hereinafter, exemplary embodiments which are examples of the invention will be described.

As a device for charging an image holding member, a non-contact corona discharger has been used, but in recent years, a contact-type (or approaching-type) charging mechanism is widely used, in order to avoid undesired generation of ozone and to realize a small-sized apparatus, energy saving, and cost reduction. A bias charge roll (BCR) in which a metal shaft is covered with a semiconductor elastic material in a layer shape is representative of a contact-type charger, but in this case, since the charging is performed by locally discharging a portion where the surface of the roll contacts with the surface of the image holding member, it is important to maintain each surface to be clean, in order to form an excellent latent image. When a charging process is performed in a state where cleaning properties are poor and toner or “foreign materials” such as external additives remain on the surface of the image holding member, uniform charging is disturbed, compounds (discharge products) accompanied with the discharging are easily formed, and this may penetrate and change the properties of the surface of the image holding member or become viscous components to promote the adhesion of foreign materials. From these viewpoints, in an electrophotography process using a contact-type charging mechanism such as BCR, a role of a cleaning process becomes more important from a viewpoint of maintaining image quality over time.

In a cleaning process using a blade, since frictional resistance of a contact surface between a blade formed of an elastic material (elastic blade) and a surface of an image holding member is great, it is difficult to cause the elastic blade to slide the upper portion of the surface of the image holding member with the configuration described above. Therefore, it is necessary to use lubricant components, and thus, a material called a lubricant may be used by using various methods. In addition, a functional design in which, when an additive (external additive) applied to a surface of the toner particle is separated from the surface of the toner particle and moved to a surface of an image holding member in development and transfer processes and accumulated on an edge of an elastic blade (the state is referred to as dam layer formation), some additives are nipped between contact portions of the elastic blade and the image holding member and passes through the contact portions, and thus, the elastic blade is not stuck and maintains a suitable contact state, may be used.

However, the state of the supply of an external additive component to the contact portion of the elastic blade is easily changed under the conditions of development and transfer, and in a case where the supply thereof is insufficient, damages called “chatter” or “turned-up” of the elastic blade easily occurs, particularly under the conditions of a high temperature and a high humidity where a frictional force easily increases, and on the other hand, damages called “chip” or “abrasion” of the edge of the blade easily occurs, under the conditions of a low temperature and low humidity where the blade easily becomes rigid. With the collapse of the dam layer described above, a function of removing toner, an external additive, and discharge products remaining on the surface of the image holding member is easily decreased.

An elastic blade which contacts with a surface of an image holding member in a non-uniform manner, is rubbed with an image holding member to attach and accumulate a toner, an external additive, and discharge products thereto, and accordingly, a phenomenon called “filming” in which a coating film formed of a composition such as a toner and the like is formed on the surface of the image holding member easily occurs. When the filming phenomenon proceeds, charging and developing performance of the coated portion is remarkably deteriorated, and accordingly, streak-shaped or spotted image defects are formed in the printed image.

As described above, from a viewpoint of structure designing of external addition to a toner, it is necessary to maintain original charging properties or holding properties by accumulating functional particles added to the toner particle on the surface of the toner particle, and to control a structure so as to secure blade scarping performance by removing and accumulating some functional particles described above on the cleaning portion. However, as an external additive, a property of suitably removing the external additive from a surface of a toner (fluidity/adhesion) and a property of forming a dam layer without passing thereof in an edge of a blade (aggregating properties) are incompatible properties, and accordingly, a material having both properties has not been found, in the related art.

In recent years, in order to realize both high quality and a decrease in cost per sheet, a toner particle diameter has been further decreased. As long as a monodispersed toner is not used, a decrease in a median diameter means that the amount of a toner in a fine powder region (for example, equal to or smaller than 2 μm) also increases. In addition, since the toner having a small diameter may tend to have a shape closet to a spherical shape, the control thereof becomes more difficult as from a viewpoint of the cleaning mechanism.

It is known that a preparing method of these toner particles is widely divided into a dry preparing method (e.g., kneading and pulverizing method) and a wet preparing method (e.g., aggregation and coalescence method, suspension and polymerization method, and dissolution and suspension method). In order to respond the demand for high image quality in recent years, a toner prepared by using the wet preparing method capable of controlling a particle diameter and a shape is widely used. When a toner is prepared by using the wet preparing method, a small particle diameter is more easily formed, compared to a toner prepared by using the dry preparing method. For example, in a dissolution and suspension method accompanied with at least one reaction of a crosslinking reaction and an extension reaction (hereinafter, may be referred to as an “ester extension synthesis method”), toner particles having a spherical shape or a spindle shape may be formed. Although particle diameter distribution of the toner particles is narrower than the toner particles prepared by using a kneading and pulverizing method, fine powder and coarse powder are easily formed, and accordingly, toner particles having comparatively wide particle diameter distribution are easily obtained. In a case where the particle diameter distribution of the toner particles is wide, an external addition structure (a state where an external additive such as silica particles is attached to the toner particle) easily changes depending on a difference in particle diameters thereof, and spots between the particles are easily formed. The toner particles having a large particle diameter may be removed to a certain extent by using a sieve or classification, but the selecting and removing of particularly the toner particles having a small particle diameter are difficult, and accordingly, this may be causes of charging problems or transferring and cleaning problems.

In recent years, in the dissolution and suspension method, a method of adding nano-order fine organic particles at the time of granulation to cause the organic particles to be adsorbed to a surface of a liquid droplet of a toner composition is used, in order to improve controlling ability of a particle median diameter and distribution control. In order to exhibit functions, it is necessary to make the organic particles to be operated at the time of toner granulation in a state of being dispersed, and therefore, the organic particles are prepared as a unit of emulsion polymerization which easily provides a dispersion, in many cases. In order to sufficiently disperse the organic particles in an aqueous system as described above and cause the organic particles to be selectively adsorbed to a surface of a liquid droplet of a toner composition at the time of granulation, it is necessary to apply some surface active functions to the surface of the organic particles. However, the surface active functions thereof may be affected by an electrolyte and a large amount of particles are present on the surface of the toner, even after the granulation, and thus, in the method, charging properties may be affected due to environmental difference and over time, from a viewpoint of toner performance.

In addition, in the dissolution and suspension method, since particles are formed after a resin component is dissolved in an organic solvent, excellent versatility of the resin has been obtained. Meanwhile, a resin component (for example, a resin having high molecular weight or crosslinked) which is hardly dissolved in an organic solvent has poor versatility, and there is room for improvement in properties affected by a polymer resin such as fixing properties or storability. For the improvement thereof, a method of causing a crosslinking reaction in a toner after the formation of particles to realize high molecular weight in a later stage, that is, an ester extension method has been developed. However, even in the ester extension method, since it is necessary to cause an urethane reaction and a urea reaction rapidly proceeding under water atmosphere, at the time of toner granulation in an aqueous system, the stable control of the reactions and the control of the structure with resin chain extension or crosslinking in the toner are difficult to be performed, as the manufacturing scale increases. The resin chain extension or crosslinking reaction even occurs in the surface of the particle, as well as the inside of the toner particle. Particularly, when an amine terminal formed due to a reaction between an isocyanate terminal and water remains, the amine terminal affects charging properties of the toner, and accordingly, it is important to complete the urea bond reaction, but it is difficult to remove all of amine terminal, in principle. In addition, when the proceeding of the resin chain extension and the crosslinking reaction is not sufficient not only in the vicinity of the surface of the toner, but inside of the particles, not only an amine terminal derived from ketimine which is a chain extender, but the amount of an amine terminal formed from an isocyanate group which is a prepolymer increases, and in a case where the amine terminal is moved to the surface of the toner and exposed from the surface thereof with the lapse of time, this may be a cause of a change in charging properties of the toner.

Although it depends on a degree of reaction, a portion where a resin chain is extended or crosslinked due to an urethane reaction and a urea reaction may form a crystal structure due to a hydrogen bond in a NH group portion. When this is present in the vicinity of the surface of the particles of the toner, charge leakage easily occurs in this portion, and accordingly, this may affect the charging properties of the toner.

That is, the dissolution and suspension method has been advanced with various improvement methods, but charging maintaining properties derived from the measure over time may have a potential problem.

Electrostatic Charge Image Developing Toner

An electrostatic charge image developing toner (hereinafter, referred to as a “toner”) according to the exemplary embodiment is a toner including a toner particle containing a urea-modified polyester resin and vinyl resin particles in the vicinity of the surface, and an external additive.

The external additive contains silica particles having a compression aggregation degree of 60% to 95% and a particle compression ratio of 0.20 to 0.40 (hereinafter, also referred to as “specified silica particles”).

The toner according to the exemplary embodiment prevents streak-shaped filming on a surface of a photoreceptor, when the same image is repeatedly formed. The reason thereof is assumed as follows.

Silica particles as an external additive are expected to exhibit a function as a spacer (buffer function) between toner particles, in order to improve storability or fluidity. However, in general, the silica particles are collected or embedded in a recess of the surface of the toner particle or easily removed from the surface of the toner particle to be attached to and diffused in a surface of a photoreceptor at the time of development, due to an effect of a spherical shape, stirring performed in a developing unit or a force applied in a developing process or a transfer process. The external additive having a great particle diameter is hardly attached to the toner particles having a small particle diameter, and a biased attachment state is easily obtained.

Meanwhile, even in a case where the toner particle shape is close to a spherical shape, silica particles are easily isolated from the surface of the toner particle. Since an electrostatic attachment force of the toner particle having a particle diameter smaller than 2 μm increases, the transferring to a recording medium and the like is difficult to be performed and remaining on the surface of a photoreceptor is easily performed.

A shape, a particle diameter, or particle size distribution of the toner particle are mainly originated from a preparing method thereof.

Some toner transitioned to the surface of the photoreceptor from the developing unit due to the development may not be transferred to a recording medium and the like and remain on the surface of the photoreceptor. When the process proceeds to a cleaning process, the remaining toner or isolated external additive components as described above are blocked in an edge of a cleaning unit (a portion of a contact portion between a cleaning blade and a photoreceptor on a downstream side in a rotation direction) and an aggregate pressed due to pressure from the cleaning blade (hereinafter, also referred to as an “external additive dam”) is formed. The external additive dam contributes to improvement of cleaning properties of scraping and collecting residual toner particles, but the silica particles isolated from the toner particles have a small particle diameter compared to the particle diameter of the toner particle, and accordingly, the silica particles pass through the edge portion of the cleaning blade and a so-called passing may occur. When these passed silica particles are attached and fixed to the surface of the photoreceptor due to pressing force of the cleaning blade or the BCR, the particles become a core and silica particles or toner components are further attached thereto to realize a film state. In a case where a large amount of toner having a small diameter is present, the filming tends to more easily occur due to the reasons described above.

Since the silica particles generally have low adhesion to the surface, particles are hardly aggregated to each other, and accordingly bulk density tends to be low. Due to these properties, it is known that fluidity of the particles is excellent, and the silica particles are used as a fluidity improving agent of the toner.

Meanwhile, in order to increase dispersibility on the surface of the toner particles as well as the fluidity of the silica particles, a technology of improving the surface of the silica particles by using a hydrophobizing agent has been known. According to the technology, the fluidity of the silica particles and the dispersibility thereof on the surface of the toner particles are improved, but cohesion is still low.

In addition, a technology of improving the surface of the silica particles by using both a hydrophobizing agent and silicone oil has also been known. According to the technology, adhesion to the toner particles is improved and cohesion is improved. However, on the other hand, fluidity and dispersibility to the toner particles are easily decreased.

That is, in the improvement of the silica particles, fluidity and dispersibility to the toner particles, and cohesion and adhesion to the toner particles are incompatible with each other.

With respect to this, the specified silica particles having a compression aggregation degree and a particle compression ratio which satisfy the ranges described above have four excellent properties which are fluidity, dispersibility to the toner particles, cohesion, and adhesion to the toner particles.

Here, the reasons of setting the compression aggregation degree and the particle compression ratio of the specified silica particles to be in the ranges described above will be described in order.

First, the reason of setting the compression aggregation degree of the specified silica particles to be from 60% to 95% will be described.

A compression aggregation degree is an index showing cohesion of silica particles and adhesion thereof to the toner particles. This index is shown with a degree how a compact of silica particles is hardly loosened, when the compact of silica particles is obtained by compressing silica particles and dropping the compact of silica particles.

Accordingly, as a compression aggregation degree is high, bulk density of the silica particles easily increases and a cohesive force (force between molecules) tends to be increased, and adhesion to the toner particles tends to be increased. A calculating method of a compression aggregation degree will be described later, in detail.

Accordingly, the specified silica in which a compression aggregation degree is controlled to be high as 60% to 95% has excellent adhesion to the toner particles and cohesion. Here, the upper limit value of the compression aggregation degree is set as 95%, in order to secure fluidity and dispersibility to the toner particles while having excellent adhesion to the toner particles and cohesion.

Next, the reason of setting the particle compression ratio of the specified silica particles to be from 0.20 to 0.40 will be described.

The particle compression ratio is an index showing fluidity of silica particles. Specifically, the particle compression ratio is shown with a ratio of a difference between hardened apparent specific gravity and loosened apparent specific gravity of silica particles, and the hardened apparent specific gravity ((hardened apparent specific gravity—loosened apparent specific gravity)/hardened apparent specific gravity).

Accordingly, as the particle compression ratio is low, silica particles have high fluidity. When the fluidity is high, dispersibility to the toner particles also tends to increase. A calculating method of a particle compression ratio will be described later, in detail.

Accordingly, the specified silica in which a particle compression ratio is controlled to be low as 0.20 to 0.40 has excellent fluidity and dispersibility to the toner particles. Here, the lower limit value of the particle compression ratio is set as 0.20, in order to improve adhesion to the toner particles and cohesion, while having excellent fluidity and dispersibility to the toner particles.

As described above, the specific silica particles have unique properties in which flowing and dispersing to the toner particles are easily performed and the cohesive force and the adhesion to the toner particles are high. Therefore, the specified silica particles having a compression aggregation degree and a particle compression ratio which satisfy the ranges described above are silica particles having high fluidity, dispersibility to the toner particles, cohesion, and adhesion to the toner particles.

Next, an estimated operation when the specified silica particles are externally added to the toner particles will be described.

As described above, the silica particles are easily isolated from the surface of the toner particles having a small diameter, compared to the toner particles having a median diameter. The same also applies to toner particles which contains a urea-modified polyester resin, is prepared by using the ester extension synthesis method, and has wide particle size distribution on a small diameter side.

However, the specified silica particles have high fluidity and dispersibility to the toner particles, and accordingly, when the specified silica particles are externally added to toner having wide particle size distribution also containing toner particles having a small diameter, the specified silica particles are also easily attached to the surface the toner particles having a small diameter substantially in a uniform manner. Here, since the specified silica particles attached to the toner particles have high adhesion to the toner particles, movement thereof on the toner particles and isolation thereof from the toner particles hardly occurs by using a mechanical load due to stirring or the like in a developing unit. That is, a change of an external addition structure hardly occurs. Accordingly, fluidity of the toner particles increases and the high fluidity are easily maintained.

Vinyl resin particles added to the vicinity of the surface of the toner particles function as a structural support for preventing embedding of the specified silica under the stirring stress of a developer or the like, and even when the vinyl resin particles are used for a long period of time, high fluidity of the toner particles may be maintained. When the specified silica particles are attached to the surface of the toner particles substantially in a uniform manner, the high fluidity is maintained, and accordingly, frictional charging ability is also improved. Even when the nano-order fine organic particles having an electrolyte component added to the vicinity of the toner surface are included, an effect of charge leakage is prevented and charge maintaining ability with the lapse of time is also obtained.

Meanwhile, in the cleaning unit, the specified silica particles are isolated from the toner particles having a small diameter due to electrical and mechanical loads due to development and transfer, but since the specified silica particles supplied to the edge of the cleaning unit have high cohesion, the specified silica particles are aggregated due to the pressure from the cleaning blade and a rigid external additive dam is formed. Accordingly, even when the specified silica particles are isolated from the toner particles having a small diameter, the specified silica particles are easily compressed and aggregated in the cleaning unit, and accordingly, the toner particles having a small diameter and the specified silica particles are hardly passed and occurrence of streak-shaped filming may be prevented.

In the toner according to the exemplary embodiment, it is more preferable that a particle dispersion degree of the specified silica particles is from 90% to 100%.

Here, the reason of setting the particle dispersion degree of the specified silica particles to be from 90% to 100% will be described.

The particle dispersion degree is an index showing dispersibility of silica particles. This index is shown with a degree how silica particles in a primary particle state are easily dispersed to the toner particles. Specifically, when a calculated coverage of silica particles to the surface of the toner particles is set as C₀ and an actually measured coverage is set as C, a particle dispersion degree is shown with a ratio of actually measured coverage C to an attachment target and calculated coverage C₀ (actually measured coverage C/calculated coverage C₀).

Accordingly, as the particle dispersion degree is high, the silica particles are hardly aggregated and in a primary particle state, the silica particles are easily dispersed to the toner particles. A calculating method of the particle dispersion degree will be described later, in detail.

In the specified silica particles, the particle dispersion degree is controlled to be high as 90% to 100% while controlling the compression aggregation degree and the particle compression ratio to be in the ranges described above, and accordingly, dispersibility thereof to the toner particles becomes more excellent. Thus, fluidity of the toner particles is further increased and the high fluidity is easily maintained. As a result, the specified silica particles are easily attached to the surface of the toner particles substantially in a uniform state.

In the toner according to the exemplary embodiment, as the specified silica particles described above having properties of high fluidity and dispersibility to the toner particles and high cohesion and adhesion to the toner particles, silica particles having a surface to which a siloxane compound having comparatively great weight average molecular weight is attached is suitably used. Specifically, silica particles having a surface to which a siloxane compound having viscosity of 1,000 cSt to 50,000 cSt is attached (preferably attached with a surface attachment amount of 0.01% by weight to 5% by weight) is suitably used. These specified silica particles are obtained by using a method of treating the surface of silica particles using a siloxane compound having viscosity of 1,000 cSt to 50,000 cSt, so that a surface attachment amount is from 0.01% by weight to 5% by weight, for example.

Here, the surface attachment amount is a ratio with respect to silica particles before treating the surface of silica particles (unprocessed silica particles). Hereinafter, the silica particles before the surface treatment (that is, unprocessed silica particles) are also simply referred to as “silica particles”.

The specified silica particles obtained by treating the surface of silica particles using a siloxane compound having viscosity of 1,000 cSt to 50,000 cSt, so that a surface attachment amount is from 0.01% by weight to 5% by weight, have increased fluidity and dispersibility to the toner particles, together with cohesion and adhesion to the toner particles, and a compression aggregation degree and a particle compression ratio easily satisfy the conditions described above. Formation of streak-shaped filming on the surface of the photoreceptor is easily prevented. The reason thereof is not clear but assumed as follows.

When a small amount of a siloxane compound having comparatively high viscosity which is in the range described above is attached to the surface of the silica particles in the range described above, a function derived from the properties of the siloxane compound on the surface of the silica particles is exhibited. The mechanism thereof is not clear, but since a small amount of the siloxane compound having comparatively high viscosity is attached in the range described above, when silica particles flow, release properties derived from the siloxane compound are easily exhibited or adhesion between silica particles is decreased due to a decrease in interparticle force due to steric hindrance of the siloxane compound. Therefore, fluidity of silica particles and dispersibility thereof to the toner particles are further increased.

Meanwhile, when the silica particles are pressurized, long molecular chains of the siloxane compound on the surface of the silica particles entangled with each other, closest packing properties of silica particles increases, and aggregation between silica particles increases. A cohesive force of silica particles due to entanglement of long molecular chains of the siloxane compound may be released, when silica particles flow. In addition, adhesion to the toner particles is also increased due to long molecular chains of the siloxane compound on the surface of the silica particles.

As described above, in the specified silica particles in which a small amount of the siloxane compound having viscosity in the range described above is attached to the surface of the silica particles in the range described above, the compression aggregation degree and the particle compression ratio easily satisfy the requirements described above and the particle dispersion degree also easily satisfies the requirements described above.

Hereinafter, the configuration of the toner will be described in detail.

Toner Particles

The toner particle contains a urea-modified polyester resin as a binder resin and a vinyl resin particle in the vicinity of the surface, and if necessary, may contain other binder resins, colorants, release agents, or other additives. Hereinafter, a binder resin which may be contained in addition to the urea-modified polyester resin will be also described in detail.

Binder Resin

Examples of the binder resin include vinyl resins formed of homopolymers of monomers such as styrenes (for example, styrene, parachlorostyrene, and α-methylstyrene), (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, laurylmethacrylate, and 2-ethylhexyl methacrylate), ethylenically unsaturated nitriles (for example, acrylonitrile and methacrylonitrile), vinyl ethers (for example, vinyl methyl ether and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers obtained by combining two or more kinds of these monomers.

Examples of the binder resin also include a non-vinyl resin such as an epoxy resin, a polyester resin, a polyurethane resin, a polyamide resin, a cellulose resin, a polyether resin, and modified rosin, mixtures thereof with the above-described vinyl resin, or graft polymer obtained by polymerizing a vinyl monomer with the coexistence of such non-vinyl resins.

These binder resins may be used alone or in combination of two or more kinds thereof.

Among these, a polyester resin is suitable.

As the polyester resin, a well-known polyester resin is used, for example.

Examples of the polyester resin include polycondensates of polyvalent carboxylic acids and polyols. A commercially available product or a synthesized product may be used as the polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adduct of bisphenol A and propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is determined by a DSC curve obtained by differential scanning calorimetry (DSC), and more specifically, is determined by “Extrapolated Starting Temperature of Glass Transition” disclosed in a method of determining a glass transition temperature of JIS K 7121-1987 “Testing Methods for Transition Temperature of Plastics”.

The weight average molecular weight (Mw) of the polyester resin is preferably from 5,000 to 1,000,000 and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100 and more preferably from 2 to 60.

The weight average molecular weight and the number average molecular weight are measured by gel permeation chromatography (GPC). The molecular weight measurement by GPC is performed by using HLC-8120 GPC, which is GPC manufactured by Tosoh Corporation as a measuring device, TSKGEL SUPERHM-M (15 cm) manufactured by Tosoh Corporation, as a column, and a THF solvent. The weight average molecular weight and the number average molecular weight are calculated using a calibration curve of molecular weight obtained with a monodisperse polystyrene standard sample from the measurement results obtained from the measurement.

A known preparing method is applied to prepare the polyester resin. Specific examples thereof include a method of conducting a reaction at a polymerization temperature set to 180° C. to 230° C., if necessary, under reduced pressure in the reaction system, while removing water or an alcohol generated during condensation.

In the case in which monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. In the case in which a monomer having poor compatibility is present in a copolymerization reaction, the monomer having poor compatibility and an acid or an alcohol to be polycondensed with the monomer may be previously condensed and then polycondensed with the main component.

Here, as the polyester resin, a terminal-modified polyester resin (modified polyester resin) is also used, in addition to the unmodified polyester resin described above. The modified polyester resin is a polyester resin in which a bonding group other than an ester bond is present, and a polyester resin in which a resin component other than the polyester resin component is bonded by covalent bonding or ionic bonding. For example, a polyester resin including crosslinked or extended resin chains by allowing a reaction between a polyester resin in which a functional group such as an isocyanate group reacting with an acid group or a hydroxyl group is introduced to a reaction terminal, and an active hydrogen compound is used. The modified polyester resin may be used alone, but is preferably used together with the polyester resin described above.

As the modified polyester resin, a urea-modified polyester resin is particularly preferable. When the urea-modified polyester resin is contained in the binder resin, crosslinking and extension reaction easily proceed in the vicinity of the surface of the particles in a water atmosphere, and accordingly, hardness of the surface of the toner particles may be selectively adjusted by controlling a reaction amount and attachment bias or embodiment of an external additive may be controlled. From this viewpoint, the content of the urea-modified polyester resin is preferably from 10% by weight to 30% by weight and more preferably from 15% by weight to 25% by weight with respect to the entire binder resin.

As the urea-modified polyester resin, a urea-modified polyester resin obtained by a reaction (at least one reaction of a crosslinking reaction and an extension reaction) between a polyester resin (polyester prepolymer) including an isocyanate group in an reaction terminal and an amine compound which is an active hydrogen compound is preferably used. The urea-modified polyester resin may contain a urea bond and an urethane bond.

As a polyester prepolymer including the isocyanate group described above, a prepolymer compound obtained by allowing a reaction of a polyvalent isocyanate compound with respect to polyester having a low molecular weight which is formed of a polycondensate of polyvalent carboxylic acid and polyol and includes active hydrogen is used. Examples of a functional group including active hydrogen applied to polyester chain terminal include a hydroxyl group (alcoholic hydroxyl group and phenolic hydroxyl group), an amino group, a carboxyl group, and a mercapto group, and among these, an alcoholic hydroxyl group is preferable.

As polyvalent carboxylic acid and polyol used for forming a polyester prepolymer including an isocyanate group, the compounds same as polyvalent carboxylic acid and polyol described in the section of the material for polyester resin synthesis are used.

Examples of a polyvalent isocyanate compound include aliphatic polyisocyanate (tetramethylene diisocyanate, hexamethylene diisocyanate, or 2,6-diisocyanato methyl caproate); alicyclic polyisocyanate (isophorone diisocyanate or cyclohexylmethane diisocyanate); aromatic diisocyanate (tolylene diisocyanate or diphenylmethane diisocyanate); aromatic aliphatic diisocyanate (α,α,α′,α′-tetramethylxylylene diisocyanate); isocyanurates; and a component obtained by blocking the polyisocyanate by a phenol derivative, oxime, or caprolactam.

The polyvalent isocyanate compounds may be used alone or in combination of two or more kinds thereof.

A ratio of the polyvalent isocyanate compound is preferably from 1/1 to 5/1, more preferably from 1.2/1 to 4/1, and even more preferably from 1.5/1 to 2.5/1, as an equivalent ratio [NCO]/[OH] of an isocyanate group [NCO] and a hydroxyl group of a polyester prepolymer including a hydroxyl group [OH]. When the ratio [NCO]/[OH] is in the range described above, a prepolymer in which an isocyanate group is introduced to a terminal may be prepared in an excellent manner. On the other hand, when the ratio [NCO]/[OH] is beyond the range described above, a reaction between an isocyanate group and a hydroxyl group become insufficient, an un-reacted terminal or an unreacted product may remain, and the crosslinking and extension reactions after that may be disturbed.

The number of isocyanate groups contained per 1 molecule of the polyester prepolymer including an isocyanate group is preferably averagely equal to or greater than 1, more preferably averagely from 1.5 to 3, and even more preferably averagely from 1.7 to 2.6. When the number of isocyanate groups is equal to or greater than 1 per 1 molecule, the extension reaction proceeds in an excellent manner and a urea-modified polyester resin having a desired molecular weight may be obtained.

Examples of the amine compound to be reacted with the polyester prepolymer including an isocyanate group include diamine, tri- or higher valent polyamine, amino alcohol, amino mercaptan, amino acid, and a compound obtained by blocking these amino groups.

Examples of diamine include aromatic diamine (phenylene diamine, diethyl toluene diamine, or 4,4′diaminodiphenylmethane); alicyclic diamine (4,4′-diamino-3,3′dimethyl dicyclohexyl methane, diamine cyclohexane, or isophorone diamine); and aliphatic diamine (ethylenediamine, tetramethylenediamine, or hexamethylenediamine).

Examples of tri- or higher valent polyamine include diethylenetriamine and triethylenetetramine.

Examples of amino alcohol include ethanolamine and hydroxyethyl aniline.

Examples of amino mercaptan include aminoethyl mercaptan and aminopropyl mercaptan.

Examples of amino acid include aminopropionic acid and aminocaproic acid.

Examples of a compound obtained by blocking these amino groups include a ketimine compound and an oxazoline compound obtained from an amine compound such as diamine, tri- or higher valent polyamine, amino alcohol, amino mercaptan, or amino acid and a ketone compound (acetone, methyl ethyl ketone, or methyl isobutyl ketone).

Among these amino compounds, a ketimine compound is preferable.

The amino compounds may be used alone or in combination of two or more kinds thereof.

A ratio of the amine compound is preferably from 1/2 to 2/1, more preferably from 1/10.5 to 1.5/1, and even more preferably from 1/1.2 to 1.2/1, as an equivalent ratio [NCO]/[NHx] of an isocyanate group [NCO] of the polyester prepolymer including an isocyanate group and an amino group [NHx] of amines. When the ratio [NCO]/[NHx] is in the range described above, the crosslinking/extension reaction proceeds in an excellent manner and a urea-modified polyester resin having a suitable molecule polymerization degree may be obtained.

The urea-modified polyester resin may be a resin in which the molecular weight or a crosslinking degree after the reaction is adjusted by adjusting a reaction between the polyester resin including an isocyanate group (polyester prepolymer) and an amine compound (at least one reaction of the crosslinking reaction and the extension reaction), using a stopper which stops at least one reaction of the crosslinking reaction and the extension reaction (hereinafter, also referred to as a “crosslinking/extension reaction stopper”).

Examples of the crosslinking/extension reaction stopper include monoamine (diethylamine, dibutylamine, butylamine, or laurylamine) and a component obtained by blocking those (ketimine compound), and monoalcohols (methyl alcohol, ethyl alcohol, n-propyl alcohol, n-butyl alcohol, isobutyl alcohol, n-pentyl alcohol, isopentyl alcohol, n-hexyl alcohol, n-octyl alcohol, n-decyl alcohol, cyclopentanol, cyclohexanol, benzyl alcohol, or diphenyl alcohol, triphenyl alcohol). Particularly preferable examples thereof include n-butyl alcohol, isobutyl alcohol, n-pentyl alcohol, isopentyl alcohol, and n-hexyl alcohol. Since these materials shows suitable reactivity as an extension reaction stopper and has a boiling point of approximately 100° C., these materials are preferable, because these materials are easily removed from a reaction system or hardly dissolved in an aqueous medium at the time of emulsion.

An addition ratio of the extension reaction stopper depends on a compound, but in a case of monoalcohols, reactivity of a prepolymer is adjusted by changing the equivalent ratio [NCO]/[OH] of an isocyanate group [NCO] in the polyester prepolymer including an isocyanate group and monoalcohol [OH] generally in a range of 1/0.01 to 1/1 and preferably in a range of 1/0.1 to 1/0.9. These extension reaction stoppers are preferably dispersed in an oil phase at the time of preparing a toner, but there is no particular limitation. The extension reaction stopper may be dispersed in a water phase in advance or may be used in an emulsion dispersion.

The content of the toner binder resin formed of urea-modified and unmodified polyester resins is, for example, preferably from 40% by weight to 95% by weight, more preferably from 50% by weight to 90% by weight, and even more preferably from 60% by weight to 85% by weight with respect to a total amount of toner particles. In a case of using a so-called clear toner without using a colorant, the content thereof is preferably from 70% by weight to 90% by weight.

Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, Rhodamine B Lake, Lake Red C, pigment red, rose bengal, aniline blue, ultramarine blue, calco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorants may be used alone or in combination of two or more kinds thereof. The colorants may not be compulsorily used and may not be used for the purpose.

As the colorant, the surface-treated colorant may be used, if necessary. The colorant may be used in combination with a dispersing agent. Plural colorants may be used in combination.

The content of the colorant is preferably from 1% by weight to 30% by weight, more preferably from 3% by weight to 15% by weight with respect to the entirety of the toner particles.

Release Agent

Examples of the release agent include hydrocarbon waxes; natural waxes such as carnauba wax, rice wax, and candelilla wax; synthetic or mineral/petroleum waxes such as Fischer Tropsch wax and montan wax; and ester waxes such as fatty acid esters and montanic acid esters. The release agent is not limited thereto.

The melting temperature of the release agent is preferably from 50° C. to 110° C. and more preferably from 60° C. to 100° C.

The melting temperature is obtained from “melting peak temperature” described in the method of obtaining a melting temperature in JIS K 7121-1987 “Testing methods for transition temperatures of plastics”, from a DSC curve obtained by differential scanning calorimetry (DSC).

The content of the release agent is, for example, preferably from 1% by weight to 20% by weight, and more preferably from 5% by weight to 15% by weight with respect to the total toner particles.

Other Additives

Examples of other additives include known additives such as a magnetic material, a charge-controlling agent, and an inorganic particle. The toner particles include these additives as internal additives.

Vinyl Resin Particles

Toner particles are formed by dispersing the organic medium in an aqueous medium phase which will be described later, and vinyl resin particles are used at that time. An average particle diameter of the resin particles used to be dispersed in an aqueous medium is preferably from 5 nm to 600 nm and more preferably from 20 nm to 300 nm.

A glass transition point (Tg) of the resin configuring the vinyl resin particles is preferably from 40° C. to 90° C. and more preferably from 50° C. to 70° C. When the Tg is excessively low, toner storability is deteriorated, and blocking may occur during storage and in a developing device. On the other hand, when the Tg is excessively high, the vinyl resin particles disturb adhesion between a recording medium (for example, paper) and a toner layer, the lowest temperature at which fixing may be performed increases, and a temperature region in which sufficient fixing is performed is hardly secured. That is, a low-temperature fixing may not be performed.

A weight average molecular weight (Mw) of a resin configuring the vinyl resin particles is preferably equal to or smaller than 200,000 and more preferably equal to or smaller than 80,000. When the weight average molecular weight thereof is excessively high, this causes disturbance of adhesion with a recording medium, in the same manner as a case of Tg.

The vinyl resin particles are present in the vicinity of the surface of the toner particle, and the vicinity of the surface indicates a region from a portion of a depth of 1 μm in the inside direction (depth direction) from the surface of the toner particle (state in which vinyl resin particles are embedded), to a portion in a state where the vinyl resin particles are attached to the surface of the toner particle (state in which vinyl resin particles are exposed).

As long as the vinyl resin particles do not completely cover the toner particle, the vinyl resin particles may be disposed in the vicinity of the surface in a state of being contacted or melted.

The presence of the vinyl resin particles in the vicinity of the surface of the toner particle may be checked from the appearance of the toner particles or by an electron microscope observation of the cross section of the toner particle.

When this vinyl resin particles are a resin capable of forming a dispersing element in an aqueous medium, a resin other than the vinyl resin may be used together or vinyl resin particles obtained by chemical modification of a vinyl resin with a resin other than the vinyl resin may be used. As a resin which may be used together with the vinyl resin or used for chemical modification of the vinyl resin, a thermoplastic resin or a thermosetting resin may be used, and examples thereof include a polyurethane resin, an epoxy resin, a polyester resin, a polyamide resin, a polyimide resin, a silicon resin, a phenol resin, a melamine resin, a urea resin, an aniline resin, an ionomer resin, and a polycarbonate resin. These may be used alone or in combination of two or more kinds thereof. Among these, a polyurethane resin, an epoxy resin, a polyester resin, or a combination thereof is preferably used, in addition to the vinyl resin, because an aqueous dispersing element of uniform spherical resin particles is easily obtained.

The vinyl resin is obtained by homopolymerization or copolymerization of a vinyl monomer by performing emulsion polymerization or the like, and examples thereof include a styrene-(meth)acrylate copolymer, a styrene-butadiene copolymer, a (meth)acrylic acid-acrylate copolymer, a styrene-acrylonitrile copolymer, a styrene-maleic anhydride copolymer, and a styrene-(meth)acrylic acid copolymer.

Aqueous Medium

In the exemplary embodiment, as an aqueous medium for forming an aqueous medium phase by dispersing the resin particles described above, water may be used alone or a solvent capable of being mixed with water may be used in combination. A well-known material is used as a solvent to be mixed and examples thereof include alcohols (methanol, isopropanol, and ethylene glycol), dimethylformamide, tetrahydrofuran, cellosolves (methyl cellosolve), and lower ketones (acetone and methylethylketone). These may be used alone or in combination of two or more kinds thereof.

When an organic solvent soluble in which a polyester prepolymer is soluble is used, a viscosity when a resin component contained in the organic solvent phase is dispersed in an aqueous medium may be decreased, and accordingly, the organic solvent is preferable, in order to sharpen particle size distribution of toner particles to be formed. The solvent is preferable, because distillation is easily performed, when volatility is exhibited, when a temperature is lower than 100° C.

Examples of the organic solvent include toluene, xylene, benzene, carbon tetrachloride, methylene chloride, 1,2-dichloroethane, 1,1,2-trichloroethane, trichlorethylene, chloroform, monochlorobenzene, dichloroethylidene, methyl acetate, ethyl acetate, methyl ethyl ketone, and methyl isobutyl ketone, and these may be used alone or in combination of two or more kinds thereof. Particularly, an aromic solvent such as toluene or xylene; halogenated hydrocarbon such as methylene chloride, 1,2-dichloroethane, chloroform or carbon tetrachloride; methyl acetate, and ethyl acetate are preferable. The amount of the solvent used with respect to 100 parts of the polyester prepolymer is normally from 0 part to 300 parts, preferably from 0 part to 100 parts, and more preferably from 10 parts to 75 parts. In a case where the solvent is used, the solvent is heated and distilled under normal pressure or reduced pressure, in the same manner as the other organic solvents, after forming urea-modified polyester.

Characteristics of Toner Particles

The toner particles may be toner particles having a single-layer structure, or toner particles having a so-called core/shell structure composed of a core part (core particle) and a coating layer (shell layer) coated on the core part.

Here, toner particles having a core/shell structure is preferably composed of, for example, a core part containing a binder resin, and if necessary, other additives such as a colorant and a release agent and a coating layer containing a binder resin.

Based on the principle of the preparing method, the toner particles contained in the toner according to the exemplary embodiment have a particle size distribution containing a large amount of a so-called fine powder component having a diameter smaller than a median diameter (for example, number particle size distribution index (GSDp) on the small diameter side is equal to or greater than 1.24). In general, when an image is formed by using a toner having a large amount of a component having fine powder diameter (fine powder), a load is applied in a cleaning process by increasing the number of toners not transferred, and thus, the streak-shaped filming easily occurs on a surface of a photoreceptor. However, by containing the specified silica particles as an external additive, occurrence of the streak-shaped filming on a surface of a photoreceptor may be effectively prevented.

The volume average particle diameter (D_{50V}) of the toner particles is preferably from 2 μm to 10 μm, and more preferably from 3 μm to 8 μm.

Here, a method of measuring a particle size distribution and a volume average particle diameter D₅₀ᵥ of toner particles will be described.

In a case where an external additive is attached to the toner particles, the external additive is separated from the toner as follows.

As a dispersant, a toner is put into a 5% aqueous solution of a surfactant (sodium alkyl benzene sulfonate is preferable) and seeped by stirring. Then, a resultant material is processed in a bathtub type ultrasonic disperser to isolate the external additive from the surface of the toner, and after the process, the toner component is precipitated due to centrifugal separation. A supernatant in which the external additive is isolated and dispersed is removed and this operation is repeated three times.

The particle size distribution and the volume average particle diameter D_{50V} of toner particles (precipitated component) from which the external additive is separated by the method described above are measured using a COULTER MULTISIZER II (manufactured by Beckman Coulter, Inc.) and ISOTON-II (manufactured by Beckman Coulter, Inc.) as an electrolyte.

In the measurement, approximately 50 mg of a measurement sample (wet product) is added to 2 ml of a 5% aqueous solution of surfactant (preferably sodium alkylbenzene sulfonate) as a dispersing agent. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle diameter of 2 μm to 60 μm is measured by a Coulter Multisizer II using an aperture having an aperture diameter of 100 μm. 50,000 particles are sampled.

Cumulative distributions by volume and by number are drawn from the side of the smallest diameter with respect to particle size ranges (channels) separated based on the measured particle size distribution. The particle diameter when the cumulative percentage becomes 16% is defined as that corresponding to a volume average particle diameter D₁₆ᵥ and a number average particle diameter D₁₆ₚ, while the particle diameter when the cumulative percentage becomes 50% is defined as that corresponding to a volume average particle diameter D₅₀ᵥ and a number average particle diameter D₅₀ₚ. Furthermore, the particle diameter when the cumulative percentage becomes 84% is defined as that corresponding to a volume average particle diameter D₈₄ᵥ and a number average particle diameter D₈₄ₚ.

Using these, a volume particle size distribution index (GSDv) is calculated as (D₈₄ᵥ/D₁₆ᵥ)^{1/2}, while a number particle size distribution index (GSDp) is calculated as (D₈₄ₚ/D₁₆ₚ)^{1/2} and a small-diameter side number particle size distribution index (GSDp) is calculated as (D₅₀ₚ/D₁₆ₚ)^{1/2}.

A preparing method of vinyl resin particles used in the exemplary embodiment is not particularly limited, and a dry preparing method or a wet preparing method may be used. A wet preparing method is preferable and an emulsion polymerization method is more preferable, in order to obtain resin particles having narrow particle size distribution.

The vinyl resin particles present in the vicinity of the surface of the toner particles indicates a state where a substance causing leakage of charge is attached to the vicinity of the surface of the toner particles, and accordingly, in general, charging stability is not obtained. However, when the vinyl resin particles are present in the vicinity of the surface of the toner particles in a particulate state, or a stitch state or a sea-island structure state obtained by gentle coalescing of particles, and the specified silica particles are dispersed to the surface of the toner particles, the charging stability is obtained.

External Additive

The external additive contains the specified silica particles. The external additive may contain external additives other than the specified silica particles. That is, only the specified silica particles may be externally added to the toner particles or the specified silica particles and other external additives may be externally added to the toner particles.

Specified Silica Particles

Compression Aggregation Degree

The compression aggregation degree of the specified silica particles is from 60% to 95%, and is preferably from 65% to 95% and more preferably from 70% to 95%, in order to secure fluidity and dispersibility to the toner particles while having excellent cohesion and adhesion to the toner particles regarding the specified silica particles (that is, to prevent occurrence of streak-shaped filming on a surface of a photoreceptor).

The compression aggregation degree is calculated by the following method.

A disc-shaped mold having a diameter of 6 cm is filled with 6.0 g of the specified silica particles. Then, the mold is compressed with a compressive molding device (manufactured by Maekawa Testing Machine MFG. Co., Ltd.) under pressure of 5.0 t/cm² for 60 seconds, and compressed disc-shaped compact of the specified silica particles (hereinafter, referred to as a “compact before dropping”) is obtained. After that, the weight of the compact before dropping is measured.

Then, the compact before dropping is disposed on a sieving screen having an aperture of 600 μm, and the compact before dropping is dropped by using a vibrational sieving machine (product name: VIBRATING MVB-1 manufactured by Tsutsui Scientific Instruments Co., Ltd.) under the conditions of amplitude of 1 mm and vibrating time of 1 minute. Accordingly, the specified silica particles are dropped from the compact before dropping through the sieving screen and the compact of the specified silica particles remain on the sieving screen. Then, the weight of the remaining compact of the specified silica particles (hereinafter, referred to as a “compact after dropping”) is measured.

The compression aggregation degree is calculated from a ratio of the weight of the compact after the dropping and the weight of the compact before the dropping by using the following Equation (1).

compression aggregation degree=(weight of the compact after the dropping/weight of the compact before the dropping)×100 Equation (1):

Particle Compression Ratio

The particle compression ratio of the specified silica particles is from 0.20 to 0.40, and is preferably from 0.24 to 0.38 and more preferably from 0.28 to 0.36, in order to secure fluidity and dispersibility to the toner particles while having excellent cohesion and adhesion to the toner particles regarding the specified silica particles (that is, to prevent occurrence of streak-shaped filming on a surface of a photoreceptor).

The particle compression ratio is calculated by the following method.

The loosened apparent specific gravity and the hardened apparent specific gravity of silica particles are measured by using a powder tester (product number PT-S type manufactured by Hosokawa Micron Group). The particle compression ratio is calculated from a ratio of a difference between the hardened apparent specific gravity and the loosened apparent specific gravity of silica particles, and the hardened apparent specific gravity by using the following Equation (2).

particle compression ratio=(hardened apparent specific gravity−loosened apparent specific gravity)/hardened apparent specific gravity) Equation (2):

The “loosened apparent specific gravity” is a measurement value calculated by filling a container having volume of 100 cm³ with silica particles and measuring the weight thereof, and is filling specific gravity of a state where the specified silica particles are naturally dropped in the container. The “hardened apparent specific gravity” is apparent specific gravity obtained from a state where impact is repeatedly applied (tapping) to the bottom portion of the container 180 times with a stroke length of 18 mm and a tapping rate of 50/min from the state of the loosened apparent specific gravity, to cause deaeration, rearrangement of the specified silica particles, and filing in a more dense state.

Particle Dispersion Degree

The particle dispersion degree of the specified silica particles is preferably from 90% to 100%, more preferably 100%, in order to obtain more excellent dispersibility to the toner particles.

The particle dispersion degree is a ratio of the actually measured coverage C to the toner particles and the calculated coverage C₀ and is calculated by using the following Equation (3).

particle dispersion degree=actually measured coverage C/calculated coverage C₀ Equation (3):

Here, when a volume average particle diameter of the toner particles is set as dt (m), an average equivalent circle diameter of the specified silica particles is set as da (m), specific gravity of the toner particles is set as ρt, specific gravity of the specified silica particles is set as ρa, a weight of the toner particles is set as Wt (kg), and the amount of the specified silica particles added is set as Wa (kg), the calculated coverage C₀ to the surface of the toner particles with the specific silica particles may be calculated by the following Equation (3-1).

calculated coverage C₀=√3/(2π)×(ρt/ρa)×(dt/da)×(Wa/Wt)×100(%) Equation (3-1):

Regarding only the toner particles, only the specific silica particles, and toner particles covered (attached) with the specific silica particles, signal intensity of silicon atoms derived from the specified silica particles is respectively measured by using an X-ray photoelectron spectroscopy (XPS) (“JPS-9000MX” manufactured by JEOL Ltd.), and the actually measured coverage C to the surface of the toner particles with the specified silica particles may be calculated by the following Equation (3-2).

actually measured coverage C=(z−x)/(y−x)×100(%) Equation (3-2):

(In Equation (3-2), x represents signal intensity of silicon atoms derived from the specific silica particles with only the toner particles. y represents signal intensity of silicon atoms derived from the specific silica particles with only the specific silica particles. z represents signal intensity of silicon atoms derived from the specific silica particles with the toner particles covered (attached) with the specific silica particles.)

Average Equivalent Circle Diameter

An average equivalent circle diameter of the specific silica particles is preferably from 40 nm to 200 nm, more preferably from 50 nm to 180 nm, and even more preferably from 60 nm to 160 nm, in order to have excellent fluidity, dispersibility to the toner particles, cohesion, and adhesion to the toner particles regarding the specified silica particles (particularly, in order to prevent occurrence of streak-shaped filming on a surface of a photoreceptor).

Regarding the average equivalent circle diameter D50 of the specific silica particles, primary particles after the specific silica particles are externally added to the toner particles are observed with a scanning electron microscope (SEM) (S-4100 manufactured by Hitachi, Ltd.), an image thereof is captured, the image is put in an image analyzer (LUZEX III manufactured by NIRECO), the area for each particle is measured by image analysis of the primary particles, and an equivalent circle diameter is calculated from this area value. A 50% diameter (D50) in cumulative frequency based on a volume of the obtained equivalent circle diameter is set as an average equivalent circle diameter D50 of the specific silica particles. The magnification of an electron microscope is adjusted so as to observe approximately 10 to 50 specified silica particles in one visual field, and observations of plural visual fields are combined with each other to determine an equivalent circle diameter of primary particles.

Average Circularity

The shape of the specified silica particles may be any of a spherical shape or a deformed shape, and an average circularity of the specified silica particles is preferably from 0.85 to 0.98, more preferably from 0.90 to 0.98, and even more preferably from 0.93 to 0.98, in order to have excellent fluidity, dispersibility to the toner particles, cohesion, and adhesion to the toner particles regarding the specified silica particles (particularly, in order to prevent occurrence of streak-shaped filming on a surface of a photoreceptor).

The average circularity of the specified silica particles is measured by the following method.

First, primary particles after the specific silica particles are externally added to the toner particles are observed with a SEM device, and a circularity of the specified silica particles is obtained as “100/SF2” calculated from the obtained plan image analysis of the primary particles by the following equation.

circularity(100/SF2)=4π×(A/I²) Equation:

In the equation, I represents the circumference of the primary particles on an image and A represents projected area of the primary particles.

The average circularity of the specified silica particles is obtained as 50% circularity in cumulative frequency of the circularity of 100 primary particles obtained by plan image analysis.

Here, a method of measuring each of properties (compression aggregation degree, particle compression ratio, particle dispersion degree, and average circularity) of the specified silica particles will be described.

First, the external additive (specified silica particles) is separated from the toner as follows.

A toner is put into methanol and seeped by stirring. Then, a resultant material is processed in a bathtub type ultrasonic disperser to isolate the external additive from the surface of the toner particles, and after the process, the toner component is precipitated due to centrifugal separation. Only a methanol supernatant in which the specified silica particles are dispersed is collected and only methanol is distilled from the dispersion, to obtain specified silica particles.

Each of the properties described above is measured by using the separated specified silica particles.

Hereinafter, a configuration of the specified silica particles will be described in detail.

Specified Silica Particles

The specified silica particles are particles including silica (that is, SiO₂) as a main component and may be crystalline or amorphous. The specified silica particles may be particles prepared using water glass or a silicon compound such as alkoxysilane as a raw material or may be particles obtained by pulverizing quartz.

Specific examples of the specific silica particles include silica particles prepared by using a sol gel method (hereinafter, “sol-gel silica particles”), aqueous colloidal silica particles, alcoholic silica particles, fumed silica particles obtained by a gas phase method, and fused silica particles, and among these sol-gel silica particles are preferable.

Surface Treatment

In order to set the compression aggregation degree, the particle compression ratio, and the particle dispersion degree to be in the specific ranges described above, the specified silica particles are preferably surface-treated by using a siloxane compound.

As a surface treatment method, supercritical carbon dioxide is used and the surface of the silica particles is preferably treated in supercritical carbon dioxide. The surface treatment method will be described later.

Siloxane Compound

The siloxane compound is not particularly limited, as long as it includes a siloxane skeleton in a molecular structure.

Examples of the siloxane compound include silicone oil and silicone resins. Among these, silicone oil is preferable, in order to perform the surface treatment with respect to the surface of the silica particles substantially in a uniform state.

Examples of silicone oil include dimethyl silicone oil, methyl hydrogen silicone oil, methylphenyl silicone oil, amino-modified silicone oil, epoxy-modified silicone oil, carboxyl-modified silicone oil, carbinol-modified silicone oil, methacryl-modified silicone oil, mercapto-modified silicone oil, phenol-modified silicone oil, polyether-modified silicone oil, methyl styryl modified silicone oil, alkyl-modified silicone oil, higher fatty acid ester modified silicone oil, higher fatty acid amides modified silicone oil, and fluorine-modified silicone oil. Among these, dimethyl silicone oil, methyl hydrogen silicone oil, and amino-modified silicone oil are preferable.

The siloxane compound may be used alone or in combination of two or more kinds thereof.

Viscosity

The viscosity (kinematic viscosity) of the siloxane compound is preferably from 1,000 cSt to 50,000 cSt, more preferably from 2,000 cSt to 30,000 cSt, and even more preferably from 3,000 cSt to 10,000 cSt, in order to have excellent fluidity, dispersibility to the toner particles, cohesion, and adhesion to the toner particles regarding the specified silica particles (particularly, in order to prevent occurrence of streak-shaped filming on a surface of a photoreceptor).

The viscosity of the siloxane compound is determined with the following procedure. Toluene is added to the specified silica particles and dispersed with an ultrasonic disperser for 30 minutes. Then, a supernatant is collected. At this time, a toluene solution of a siloxane compound having concentration of 1 g/100 ml is obtained. Specific viscosity [ηₛₚ] (25° C.) at this time is determined by the following Equation (A).

ηₛₚ=(η/η₀)−1(η₀:viscosity of toluene,η:viscosity of solution) Equation (A):

Next, the specific viscosity [ηₛₚ] is substituted into a relational expression of Huggins shown in the following Equation (B) and intrinsic viscosity Hi is obtained.

ηₛₚ=[η]+K′[η]²(K′:constant of Huggins,K′=0.3(when[i]=1 to 3)) Equation (B):

Next, the intrinsic viscosity [η] is substituted into an equation of A. Kolorlov shown in the following Equation (C) and molecular weight M is obtained.

[η]=0.215×10⁻⁴M^{0.65} Equation (C):

The molecular weight M is substituted into an equation of A. J. Barry shown in the following Equation (D) to obtain siloxane viscosity [η].

log η=1.00+0.0123M^{0.5} Equation (D):

Surface Attachment Amount

A surface attachment amount of the siloxane compound to the surface of the specific silica particles is preferably from 0.01% by weight to 5% by weight, more preferably from 0.05% by weight to 3% by weight, and even more preferably from 0.10% by weight to 2% by weight, in order to have excellent fluidity, dispersibility to the toner particles, cohesion, and adhesion to the toner particles regarding the specified silica particles (particularly, in order to prevent occurrence of streak-shaped filming on a surface of a photoreceptor).

The surface attachment amount is measured by the following method.

100 mg of the specified silica particles is dispersed in 1 mL of chloroform, 1 μL of DMF (N,N-dimethylformamide) is added as an internal reference solution, the mixed solution is subjected to ultrasonic treatment by using an ultrasonic cleaning device for 30 minutes, and the siloxane compound is extracted in a chloroform solvent. After that, hydrogen nuclear spectrum measurement is performed with JNM-AL400 type nuclear magnetic resonance apparatus (manufactured by JEOL Ltd.) to obtain the amount of the siloxane compound from a ratio of a siloxane compound derived peak area with respect to DMF derived peak area. The surface attachment amount is obtained from the amount of siloxane compound.

Here, the specified silica particles are surface-treated with a siloxane compound having viscosity of 1,000 cSt to 50,000 cSt and the surface attachment amount of the siloxane compound to the surface of the specified silica particles is preferably from 0.01% by weight to 5% by weight.

By satisfying the above requirements, it is easy to obtain specified silica particles having excellent fluidity and dispersibility to the toner particles and improved cohesion and adhesion to the toner particles.

Amount Externally Added

The amount (content) of the specified silica particles externally added is preferably from 0.1% by weight to 6.0% by weight, more preferably from 0.2% by weight to 4.0% by weight, and even more preferably from 0.3% by weight to 3.0% by weight with respect to the toner particles, in order to prevent occurrence of the streak-shaped filming on a surface of a photoreceptor.

Method of Preparing Specified Silica Particles

The specified silica particles are obtained by performing surface treatment with respect to the surface of silica particles by using a siloxane compound having a viscosity of 1,000 cSt to 50,000 cSt, so that the surface attachment amount is from 0.01% by weight to 5% by weight with respect to silica particles.

According to the method of preparing specified silica particles, silica particles having excellent fluidity and dispersibility to the toner particles and improved cohesion and adhesion to the toner particles are obtained.

As the surface treatment method, a method of performing surface treatment with respect to a surface of silica particles using a siloxane compound in supercritical carbon dioxide; and a method of performing surface treatment with respect to a surface of silica particles using a siloxane compound in the atmosphere are used.

Specific examples of the surface treatment method include a method of dissolving a siloxane compound in supercritical carbon dioxide using supercritical carbon dioxide to attach the siloxane compound to a surface of silica particles; a method of applying (for example, spraying or applying) a solution containing a siloxane compound and a solvent including a dissolved siloxane compound to a surface of silica particles in the atmosphere to attach the siloxane compound to the surface of silica particles; and a method of adding and maintaining a solution containing a siloxane compound and a solvent including a dissolved siloxane compound to a silica particle dispersion in the atmosphere, and drying a mixed solution of the silica particle dispersion and the solution.

Among these, the method of attaching a siloxane compound to a surface of silica particles using supercritical carbon dioxide is preferable.

When the surface treatment is performed in supercritical carbon dioxide, a siloxane compound is dissolved in supercritical carbon dioxide. Since supercritical carbon dioxide has low interfacial tension, the siloxane dissolved in supercritical carbon dioxide may be easily dispersed and approach a deep portion of a porous portion of the surface of the silica particles together with supercritical carbon dioxide. Accordingly, the surface treatment performed with the siloxane compound may be performed to the deep portion of the porous portion, not only in the surface of silica particles.

Thus, the silica particles surface-treated with the siloxane compound in supercritical carbon dioxide may be silica particles having surface treated with the siloxane compound substantially in a uniform state (for example, a surface-treated layer is formed in a thin film shape).

In the method of preparing the specified silica particles, the surface treatment of applying hydrophobicity to a surface of silica particles may be performed in supercritical carbon dioxide by using a siloxane compound and a hydrophobizing agent.

In this case, the siloxane compound and the hydrophobizing agent are dissolved in supercritical carbon dioxide. The siloxane compound and the hydrophobizing agent dissolved in supercritical carbon dioxide may be easily dispersed and approach a deep portion of a porous portion of the surface of the silica particles together with supercritical carbon dioxide. Accordingly, the surface treatment performed with the siloxane compound and the hydrophobizing agent may be performed to the deep portion of the porous portion, not only in the surface of silica particles.

As a result, the silica particles which are surface-treated with the siloxane compound and the hydrophobizing agent in supercritical carbon dioxide have the surface which treated with the siloxane compound and the hydrophobizing agent substantially in a uniform state and high hydrophobicity is easily imparted.

In the method of preparing the specified silica particles, supercritical carbon dioxide may be used in other preparing process of silica particles (for example, a solvent removing process).

As a method of preparing specified silica particles using supercritical carbon dioxide in other preparing processes, a method of preparing silica particles including a process of preparing a silica particle dispersion containing silica particles and a solvent containing alcohol and water by using a sol-gel method (hereinafter, referred to as a “dispersion preparation process”), a process of removing the solvent from the silica particle dispersion by circulating supercritical carbon dioxide (hereinafter, referred to as a “solvent removing process”), and a process of performing surface treatment of the surface of silica particles after removing the solvent by using a siloxane compound in supercritical carbon dioxide (hereinafter, referred to as a “surface treatment process”) is used.

When the solvent removing from the silica particle dispersion is performed by using supercritical carbon dioxide, formation of coarse powder is easily prevented.

The reasons thereof are not clear but the following two reasons are assumed. 1) in a case of removing the solvent of the silica particle dispersion, supercritical carbon dioxide may remove the solvent without aggregation of particles due to a liquid crosslinking force when removing the solvent, with properties of “poor interfacial tension” of supercritical carbon dioxide. 2) with properties of “carbon dioxide in a state of a temperature and pressure equal to or greater than a critical point has both diffusibility of gas and solubility of liquid” of supercritical carbon dioxide, since the solvent efficiently comes into contact with and is dissolved in supercritical carbon dioxide a comparatively low temperature (for example, equal to or lower than 250° C.), the solvent in the silica particle dispersion may be removed without forming coarse powder such as secondary aggregate due to condensation of a silanol group, by removing supercritical carbon dioxide in which the solvent is dissolved.

Here, the solvent removing process and the surface treatment process are individually performed, but are preferably performed continuously (that is, each process is performed in a state of not being opened under the atmospheric pressure). These processes are continuously performed, and the surface treatment process is performed after the solvent removing process in a state where absorption of excessive amount of moisture to the silica particles is prevented, by not allowing the absorption of moisture by the silica particles. Accordingly, it is not necessary to use a large amount of siloxane compound, or to perform the solvent removing process and the surface treatment process at a high temperature where excessively heating is performed. As a result, formation of coarse powder is more efficiently performed.

Hereinafter, the method of preparing the specified silica particles and each process will be described in detail.

The method of preparing the specified silica particles is not limited thereto and may be performed 1) by using supercritical carbon dioxide only in the surface treatment process or 2) by performing each process separately.

Hereinafter, each process will be described in detail.

Dispersion Preparation Process

In the dispersion preparing process, a silica particle dispersion containing silica particles and a solvent containing alcohol and water is prepared, for example.

Specifically, in the dispersion preparing process, a silica particle dispersion is prepared by a wet method (for example, a sol-gel method), for example. Particularly, a silica particle dispersion may be prepared by using a sol-gel method as a wet method, specifically, by preparing silica particles by allowing reactions (hydrolysis reaction and condensation reaction) of tetraalkoxysilane with a solvent including alcohol and water under the presence of an alkali catalyst.

The preferable range of the average equivalent circle diameter of the silica particles and the preferable range of the average circularity thereof are as described above.

In the dispersion preparation process, in a case of obtaining silica particles by a wet method, for example, a dispersion in which silica particles are dispersed in the solvent (silica particle dispersion) is obtained.

Here, when the process proceeds to the solvent removing process, a weight ratio of water with respect to alcohol in the silica particle dispersion prepared may be, for example, from 0.05 to 1.0, and is preferably from 0.07 to 0.5 and more preferably from 0.1 to 0.3.

In the silica particle dispersion, when the weight ratio of water with respect to alcohol thereof is in the range described above, it is easy to obtain silica particles having excellent charge resistance in which coarse powder of silica particles is hardly formed after the surface treatment.

When the weight ratio of water with respect to alcohol is lower than 0.05, in the solvent removing process, since condensation of a silanol group on the surface of the silica particles when removing the solvent hardly occurs, the amount of moisture absorbed to the surface of the silica particles after the solvent removing increases, and thus, electric resistance of the silica particles after the surface treatment become excessively low. When the weight ratio of water exceeds 1.0, in the solvent removing process, a large amount of water remains in the silica particle dispersion, when the solvent removing is almost finished, aggregation of silica particles easily occurs due to liquid crosslinking force, and coarse powder is present after the surface treatment.

When the process proceeds to the solvent removing process, a weight ratio of water with respect to silica particles of the silica particle dispersion prepared may be, for example, from 0.02 to 3, and is preferably from 0.05 to 1, and more preferably from 0.1 to 0.5.

In the silica particle dispersion, when the weight ratio of water with respect to silica particles thereof is in the range described above, it is easy to obtain silica particles having excellent charge resistance in which coarse powder of silica particles is hardly formed.

When the weight ratio of water with respect to silica particles is lower than 0.02, in the solvent removing process, since condensation of a silanol group on the surface of the silica particles when removing the solvent hardly occurs, the amount of moisture absorbed to the surface of the silica particles after the solvent removing increases, and thus, electric resistance of the silica particles become excessively low.

When the weight ratio of water exceeds 3, in the solvent removing process, a large amount of water remains in the silica particle dispersion, when the solvent removing is almost finished, and aggregation of silica particles easily occurs due to liquid crosslinking force.

When the process proceeds to the solvent removing process, a weight ratio of silica particles with respect to the silica particle dispersion of the silica particle dispersion prepared may be, for example, from 0.05 to 0.7, and is preferably from 0.2 to 0.65 and more preferably from 0.3 to 0.6.

When the weight ratio of silica particles with respect to the silica particle dispersion is lower than 0.05, in the solvent removing process, the amount of supercritical carbon dioxide used increases and productivity may be deteriorated.

When the weight ratio of silica particles with respect to the silica particle dispersion is greater than 0.7, a distance between silica particles is shortened in the silica particle dispersion, and coarse powder due to aggregation or gelation of silica particles are easily formed.

Solvent Removing Process

The solvent removing process is a process of removing the solvent of the silica particle dispersion by circulating supercritical carbon dioxide, for example.

That is, the solvent removing process is a process of removing the solvent by circulating supercritical carbon dioxide or bringing supercritical carbon dioxide to come into contact with the silica particle dispersion.

Specifically, in the solvent removing process, the silica particle dispersion is put into a sealed reaction vessel, for example. Then, liquid carbon dioxide is added and heated in the sealed reaction vessel, the pressure in the reaction vessel is increased by using a high-pressure pump, to set carbon dioxide in a supercritical state. Supercritical carbon dioxide is introduced into and discharged from the sealed reaction vessel while circulating the supercritical carbon dioxide in the sealed reaction vessel, that is, in the silica particle dispersion.

Accordingly, the solvent (alcohol and water) dissolves in the supercritical carbon dioxide and is discharged to the outside of the silica particle dispersion (outside of the sealed reaction vessel), so that the solvent is removed.

Here, supercritical carbon dioxide is carbon dioxide in a state of a temperature and pressure equal to or greater than a critical point and has both diffusibility of gas and solubility of liquid.

The temperature condition of the solvent removing, that is, a temperature of supercritical carbon dioxide may be, for example, from 31° C. to 350° C., and is preferably from 60° C. to 300° C. and more preferably from 80° C. to 250° C.

When the temperature is lower than the range described above, since the solvent is hardly dissolved in supercritical carbon dioxide, the solvent is hardly removed. In addition, coarse powder is easily formed due to a liquid crosslinking force of the solvent or supercritical carbon dioxide. Meanwhile, when the temperature is higher than the range described above, coarse powder such as secondary aggregate may be easily formed due to condensation of a silanol group on the surface of the silica particles.

The pressure condition of the solvent removing, that is, pressure of supercritical carbon dioxide may be, for example, from 7.38 MPa to 40 MPa, and is preferably from 10 MPa to 35 MPa and more preferably from 15 MPa to 25 MPa.

When the pressure is lower than the range described above, the solvent tends to be hardly dissolved in supercritical carbon dioxide, and on the other hand, when the pressure is greater than the range described above, the cost of the equipment tends to increase.

The introduction and discharge amount of supercritical carbon dioxide to and from the sealed reaction vessel may be, for example, from 15.4 L/min/m³ to 1,540 L/min/m³, and is preferably from 77 L/min/m³ to 770 L/min/m³.

When the introduction and discharge amount thereof is less than 15.4 L/min/m³, since the time is taken for the solvent removing, productivity tends to be deteriorated.

On the other hand, when the introduction and discharge amount thereof is greater than 1,540 L/min/m³, efficient solvent removing may not be performed, due to short pass of supercritical carbon dioxide and shortened contact time of the silica particle dispersion.

Surface Treatment Process

The surface treatment process is a process of performing surface treatment of the surface of silica particles using a siloxane compound in supercritical carbon dioxide, continuously from the solvent removing process.

That is, in the surface treatment process, for example, the surface of the silica particles is treated by using a siloxane compound in supercritical carbon dioxide, without performing atmosphere open, before the process proceeds from the solvent removing process, for example.

Specifically, in the surface treatment process, after the introduction and discharge of supercritical carbon dioxide to and from the sealed reaction vessel in the solvent removing process are stopped, the temperature and the pressure in the sealed reaction vessel are adjusted and the siloxane compound at a constant rate to the silica particles is put into the sealed reaction vessel, in a state where supercritical carbon dioxide is present. The surface treatment of silica particles is performed in a state where the state is maintained, that is by causing a reaction of the siloxane compound in supercritical carbon dioxide.

Here, in the surface treatment process, the reaction of the siloxane compound may be performed in supercritical carbon dioxide (that is, under the atmosphere of supercritical carbon dioxide), the surface treatment may be performed while circulating supercritical carbon dioxide (that is, introduction and discharge of supercritical carbon dioxide to and from the sealed reaction vessel), or the surface treatment may be performed without circulating.

In the surface treatment process, the amount (that is, introduction amount) of the silica particles with respect to the volume of the reaction vessel may be, for example, from 30 g/L to 600 g/L, and is preferably from 50 g/L to 500 g/L and more preferably from 80 g/L to 400 g/L.

When the amount thereof is less than the range described above, the concentration of the siloxane compound with respect to supercritical carbon dioxide decreases, the possibility of contact with the silica surface decreases, and the reaction hardly proceeds. On the other hand, when the amount thereof is greater than the range described above, the concentration of the siloxane compound with respect to supercritical carbon dioxide increases, the siloxane compound is not completely dissolved in supercritical carbon dioxide to cause insufficient dispersion, and coarse aggregates may be formed.

The density of supercritical carbon dioxide may be, for example, from 0.10 g/ml to 0.80 g/ml, and is preferably from 0.10 g/ml to 0.60 g/ml and more preferably from 0.2 g/ml to 0.50 g/ml.

When the density thereof is lower than the range described above, solubility of the siloxane compound with respect to supercritical carbon dioxide decreases and aggregate tends to be formed. On the other hand, when the density is higher than the range described above, dispersibility to the silica pores decreases, and accordingly, the surface treatment may be insufficiently performed. Particularly, the surface treatment in the range of the density may be performed with respect to the sol-gel silica particles containing a large amount of a silanol group.

The density of supercritical carbon dioxide is adjusted by a temperature and pressure.

Specific examples of the siloxane compound are as described above. The preferable range of the viscosity of the siloxane compound is also as described above.

Among the siloxane compounds, when silicone oil is used, silicone oil is easily attached to the surface of the silica particles substantially in a uniform state, and fluidity, dispersibility, and handling properties of silica particles are easily improved.

The amount of the siloxane compound used may be, for example, from 0.05% by weight to 3% by weight, and is preferably from 0.1% by weight to 2% by weight and more preferably from 0.15% by weight to 1.5% by weight with respect to silica particles, in order to easily control the surface attachment amount thereof to the silica particles to be from 0.01% by weight to 5% by weight.

The siloxane compound may be used alone, but may be used as a mixed solution with a solvent in which the siloxane compound is easily dissolved. Examples of the solvent include toluene, methylethylketone, and methyl isobutyl ketone.

In the surface treatment process, the surface treatment of the silica particles may be performed by using a mixture containing the siloxane compound and the hydrophobizing agent.

As the hydrophobizing agent, a silane hydrophobizing agent is used, for example. As the silane hydrophobizing agent, a well-known silicon compound including an alkyl group (for example, a methyl group, an ethyl group, a propyl group, or a butyl group) is used, and specific examples thereof include silane compounds (for example, methyltrimethoxysilane, dimethyldimethoxysilane, trimethylchlorosilane, or trimethylmethoxysilane) and silazane compounds (for example, hexamethyldisilazane, or tetramethyldisilazane). The hydrophobizing agent may be used alone or in combination of two or more kinds thereof.

Among the silane hydrophobizing agent, a silicon compound including a trimethyl group such as trimethylmethoxysilane or hexamethyldisilazane (HMDS) is preferable, and hexamethyldisilazane (HMDS) is particularly preferable.

The amount of the silane hydrophobizing agent used is not particularly limited, and may be, for example, from 1% by weight to 100% by weight, and is preferably from 3% by weight to 80% by weight and more preferably from 5% by weight to 50% by weight, with respect to the silica particles.

The silane hydrophobizing agent may be used alone, but may be used as a mixed solution with a solvent in which the silane hydrophobizing agent is easily dissolved. Examples of the solvent include toluene, methylethylketone, and methyl isobutyl ketone.

The temperature condition of the surface treatment, that is, a temperature of supercritical carbon dioxide may be, for example, from 80° C. to 300° C., and is preferably from 100° C. to 250° C. and more preferably from 120° C. to 200° C.

When the temperature is lower than the range described above, surface treatment ability of the siloxane compound may be deteriorated. On the other hand, when the temperature is higher than the range described above, a condensation reaction occurring between silanol groups of the silica particles proceeds and particle aggregation may occur. Particularly, the surface treatment in the range of the density may be performed with respect to the sol-gel silica particles containing a large amount of a silanol group.

Meanwhile, the pressure condition of the surface treatment, that is, pressure of supercritical carbon dioxide may be set as any value, as long as it satisfies the density described above, and may be for example, from 8 MPa to 30 MPa, and is preferably from 10 MPa to 25 MPa and more preferably from 15 MPa to 20 MPa.

The specified silica particles are obtained through each process described above.

Other External Additives

Examples of other external additive include inorganic particles. Examples of the inorganic particles include SiO₂ (here, excluding the specified silica particles), TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂) n, Al₂O₃.2SiO₂, CaCO₃, MgCO₃, BaSO₄, and mgsO₄.

The surfaces of the inorganic particles used as the external additive may be treated with a hydrophobizing agent. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the other external additive also include resin particles (resin particles such as polystyrene, polymethyl methacrylate (PMMA), and melamine resin) and a cleaning aid (for example, a metal salt of higher fatty acid represented by zinc stearate, and fluorine polymer particles).

The amount of the other external additives externally added is, for example, preferably from 0% by weight to 10% by weight and more preferably from 0% by weight to 3% by weight with respect to the toner particles.

Method of Preparing Toner

Next, a method of preparing the toner according to the exemplary embodiment will be described.

The toner according to the exemplary embodiment is obtained by externally adding an external additive containing the specified silica particles to toner particles, after preparing toner particles including the urea-modified polyester resin and the vinyl resin particles in the vicinity of the surface.

The toner particles may be prepared using any of a dry preparing method (e.g., kneading and pulverizing method) and a wet preparing method (e.g., aggregation and coalescence method, suspension and polymerization method, and dissolution and suspension method). The toner particle preparing method is not particularly limited to these preparing methods, and a known preparing method is employed.

The dissolution and suspension method is a method of dispersing a solution in which raw materials (resin particles, pigment, or a release agent) configuring the toner particles are dissolved and dispersed in an organic solvent in which the binder resin is dissoluble, in an aqueous medium containing a particle dispersant, and removing the organic solvent, to granulate toner particles.

The aggregation and coalescence method is a method of obtaining toner particles through an aggregation process of forming an aggregate of raw materials (resin particles, pigment, or a release agent) configuring the toner particles, and a coalescence process of coalescing the aggregate.

Among these, the toner particles containing a urea-modified polyester resin as a binder resin may be obtained by using the following dissolution and suspension method.

Hereinafter, as a specific method of the dissolution and suspension method, a dissolution and suspension method (ester extension synthesis method) accompanied with at least one reaction of a crosslinking reaction and an extension reaction is shown, but there is no limitation. In the following description regarding the dissolution and suspension method, a method of obtaining toner particles containing a pigment and a release agent will be described, but a pigment and a release agent are contained in the toner particles, if necessary. In addition, a method of obtaining toner particles containing an unmodified polyester resin and a urea-modified polyester resin as binder resins will be described, but toner particles may only contain the urea-modified polyester resin as a binder resin.

Oil-Phase Solution Preparation Process

An oil-phase solution obtained by dissolving or dispersing a toner particle material containing a polyester resin, a polyester prepolymer including an isocyanate group, an amine compound, a pigment, and a release agent in an organic solvent is prepared (oil-phase solution preparation process). The oil-phase solution preparation process is a process of dissolving or dispersing the toner particle material in an organic solvent to obtain a mixed solution of the toner material.

The oil-phase solution is prepared by methods such as 1) a method of preparing an oil-phase solution by collectively dissolving or dispersing the toner material in an organic solvent, 2) a method of preparing an oil-phase solution by kneading the toner material in advance and dissolving or dispersing the kneaded material in an organic solvent, 3) a method of preparing an oil-phase solution by dissolving the unmodified polyester resin, the polyester prepolymer including an isocyanate group, and the amine compound in an organic solvent and dispersing a pigment and the release agent in the organic solvent, 4) a method of preparing an oil-phase solution by dispersing a pigment and the release agent in the organic solvent and dissolving the unmodified polyester resin, the polyester prepolymer including an isocyanate group, and the amine compound in the organic solvent, 5) a method of preparing an oil-phase solution by dissolving or dispersing toner particle materials other than the polyester prepolymer including an isocyanate group and the amine compound (the unmodified polyester resin, a pigment, and the release agent) in an organic solvent and dissolving the polyester prepolymer including an isocyanate group and the amine compound in the organic solvent, or 6) a method of preparing an oil-phase solution by dissolving or dispersing toner particle materials other than the polyester prepolymer including an isocyanate group or the amine compound (the unmodified polyester resin, a pigment, and the release agent) in an organic solvent and dissolving the polyester prepolymer including an isocyanate group or the amine compound in the organic solvent. The method of preparing the oil-phase solution is not limited thereto.

Examples of the organic solvent of the oil-phase solution include an ester solvent such as methyl acetate or ethyl acetate; a ketone solvent such as methyl ethyl ketone or methyl isopropyl ketone; an aliphatic hydrocarbon solvent such as hexane or cyclohexane; a halogenated hydrocarbon solvent such as dichloromethane, chloroform or trichloroethylene. It is preferable that these organic solvents dissolve the binder resin, a rate of the organic solvent dissolving in water is from approximately 0% by weight to 30% by weight, and a boiling point is equal to or lower than 100° C. Among the organic solvents, methyl ethyl ketone or ethyl acetate is preferable.

Suspension Preparation Process

Next, a suspension is prepared by dispersing the obtained oil-phase solution in a water-phase solution (suspension preparation process).

A reaction between the polyester prepolymer including an isocyanate group and the amine compound is performed together with the preparation of the suspension, and a urea-modified polyester resin is prepared by at least one of crosslinking or extension of the terminal of the resin.

The reaction conditions are selected according to reactivity between the structure of isocyanate group included in the polyester prepolymer and the amine compound. As an example, a reaction time is preferably from 10 minutes to 40 hours and more preferably from 2 hours to 24 hours. A reaction temperature is preferably from 0° C. to 150° C. and more preferably from 40° C. to 98° C.

As the water-phase solution, a water-phase solution obtained by dispersing a particle dispersing agent such as an organic particle dispersing agent or an inorganic particle dispersing agent in an aqueous solvent is used. In addition, as the water-phase solution, a water-phase solution obtained by dispersing a particle dispersing agent in an aqueous solvent and dissolving a polymer dispersing agent in an aqueous solvent is also used. Further, a well-known additive such as a surfactant may be added to the water-phase solution.

As the aqueous solvent, water (for example, generally ion exchange water, distilled water, or pure water) is used. The aqueous solvent may be a solvent containing water and an organic solvent such as alcohol (methanol, isopropyl alcohol, or ethylene glycol), dimethylformamide, tetrahydrofuran, cellosolves (methyl cellosolve), or lower ketones (acetone or methyl ethyl ketone).

As the organic particle dispersing agent, a hydrophilic organic particle dispersing agent is used. As the organic particle dispersing agent, vinyl resin particles of poly(meth)acrylic acid alkyl ester resin (for example, a polymethyl methacrylate resin), a polystyrene resin, or a poly(styrene-acrylonitrile) resin are used. As the organic particle dispersing agent, vinyl resin particles of a styrene acrylic resin are also used.

As the inorganic particle dispersing agent, a hydrophilic inorganic particle dispersing agent is used. Specific examples of the inorganic particle dispersing agent include particles of silica, alumina, titania, calcium carbonate, magnesium carbonate, tricalcium phosphate, clay, diatomaceous earth, or bentonite, and particles of calcium carbonate or bentonite are preferable. The inorganic particle dispersing agent may be used alone or in combination of two or more kinds thereof.

The surface of the particle dispersing agent may be subjected to surface treatment by a polymer including a carboxyl group.

As the polymer including a carboxyl group, a copolymer of at least one kind selected from salts (alkali metal salt, alkaline earth metal salt, ammonium salt, amine salt) in which α,β-monoethylenically unsaturated carboxylic acid or a carboxyl group of α,β-monoethylenically unsaturated carboxylic acid is neutralized by alkali metal, alkaline earth metal, ammonium, or amine, and α,β-monoethylenically unsaturated carboxylic acid ester is used. As the polymer including a carboxyl group, salt (alkali metal salt, alkaline earth metal salt, ammonium salt, amine salt) in which a carboxyl group of a copolymer of α,β-monoethylenically unsaturated carboxylic acid and α,β-monoethylenically unsaturated carboxylic acid ester is neutralized by alkali metal, alkaline earth metal, ammonium, or amine is also used. The polymer including a carboxyl group may be used alone or in combination with two or more kinds thereof.

Representative examples of α,β-monoethylenically unsaturated carboxylic acid include α,β-unsaturated monocarboxylic acid (acrylic acid, methacrylic acid, or crotonic acid), and α,β-unsaturated dicarboxylic acids (maleic acid, fumaric acid, or itaconic acid). Representative examples of α,β-monoethylenically unsaturated carboxylic acid ester include alkyl esters of (meth)acrylate, (meth)acrylate including an alkoxy group, (meth)acrylate including a cyclohexyl group, (meth)acrylate including a hydroxy group, and polyalkylene glycol mono(meth)acrylate.

As the polymer dispersing agent, a hydrophilic polymer dispersing agent is used. As the polymer dispersing agent, specifically, a polymer dispersing agent which includes a carboxyl group and does not include lipophilic group (hydroxypropoxy group or a methoxy group) (for example, aqueous cellulose ether such as carboxymethyl cellulose or carboxyethyl cellulose) is used.

Solvent Removing Process

Next, a toner particle dispersion is obtained by removing an organic solvent from the obtained suspension (solvent removing process). The solvent removing process is a process of preparing toner particles by removing the organic solvent contained in liquid droplets of the water-phase solution dispersed in the suspension. The method of removing the organic solvent from the suspension may be performed immediately after the suspension preparation process or may be performed after 1 minute or longer, after the suspension preparation process.

In the solvent removing process, the organic solvent may be removed from the suspension by cooling or heating the obtained suspension to have a temperature in a range of 0° C. to 100° C., for example and processing the suspension under conditions of normal pressure and reduced pressure.

As a specific method of the organic solvent removing method, the following method is used.

(1) A method of allowing airflow to blow to the suspension to forcibly update a gas phase on the surface of the suspension. In this case, gas may flow into the suspension.

(2) A method of reducing pressure. In this case, a gas phase on the surface of the suspension may be forcibly updated due to filling with gas or gas may further blow into the suspension.

The toner particles are obtained through the above-mentioned processes.

Here, after the organic solvent removing process ends, the toner particles formed in the toner particle dispersion are subjected to a well-known washing process, a well-known solid-liquid separation process, and a well-known drying process, and thereby dried toner particles are obtained.

Regarding the washing process, replacing washing using ion exchanged water may preferably be sufficiently performed for charging property.

The solid-liquid separation process is not particularly limited, but suction filtration, pressure filtration, or the like may preferably be performed for productivity. The drying process is not particularly limited, but freeze drying, flush drying, fluidized drying, vibrating fluidized drying, and the like may preferably be performed for productivity.

The toner according to the exemplary embodiment is prepared by adding and mixing the external additives to and with the dried toner particles obtained, for example.

The mixing may be performed by using a V blender, a HENSCHEL MIXER, a LÖDIGE MIXER, and the like.

Further, if necessary, coarse toner particles may be removed by using a vibration classifier, a wind classifier, and the like.

Electrostatic Charge Image Developing Developer

An electrostatic charge image developing developer according to the exemplary embodiment includes at least the toner according to the exemplary embodiment.

The electrostatic charge image developing developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coating carrier in which surfaces of cores formed of a magnetic powder are coated with a coating resin; a magnetic powder dispersion-type carrier in which a magnetic powder is dispersed and blended in a matrix resin; and a resin impregnation-type carrier in which a porous magnetic powder is impregnated with a resin.

The magnetic powder dispersion-type carrier and the resin impregnation-type carrier may be carriers in which constituent particles of the carrier are cores and coated with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

The coating resin and the matrix resin may contain other additives such as a conductive material.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Here, a coating method using a coating layer forming solution in which a coating resin, and if necessary, various additives are dissolved in an appropriate solvent is used to coat the surface of a core with the coating resin. The solvent is not particularly limited, and may be selected in consideration of the coating resin to be used, coating suitability, and the like.

Specific examples of the resin coating method include a dipping method of dipping cores in a coating layer forming solution, a spraying method of spraying a coating layer forming solution to surfaces of cores, a fluid bed method of spraying a coating layer forming solution in a state in which cores are allowed to float by flowing air, and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100, and more preferably from 3:100 to 20:100 (toner:carrier).

Image Forming Apparatus and Image Forming Method

An image forming apparatus and an image forming method according to the exemplary embodiment will be described.

The image forming apparatus according to the exemplary embodiment is provided with an image holding member, a charging unit that charges a surface of the image holding member, an electrostatic charge image forming unit that forms an electrostatic charge image on the charged surface of the image holding member, a developing unit that contains an electrostatic charge image developing developer and develops the electrostatic charge image formed on the surface of the image holding member with the electrostatic charge image developing developer as a toner image, a transfer unit that transfers the toner image formed onto the surface of the image holding member to a surface of a recording medium, a fixing unit that fixes the toner image transferred onto the surface of the recording medium, and a cleaning unit that includes a cleaning blade that cleans the surface of the image holding member. As the electrostatic charge image developing developer, the electrostatic charge image developing developer according to the exemplary embodiment is applied.

In the image forming apparatus according to the exemplary embodiment, an image forming method (image forming method according to the exemplary embodiment) including the processes of: charging a surface of an image holding member; forming an electrostatic charge image on the charged surface of the image holding member; developing the electrostatic charge image formed on the surface of the image holding member with the electrostatic charge image developing developer according to the exemplary embodiment as a toner image; transferring the toner image formed onto the surface of the image holding member to a surface of a recording medium; fixing the toner image transferred onto the surface of the recording medium; and cleaning the surface of the image holding member with a cleaning blade is performed.

As the image forming apparatus according to the exemplary embodiment, a known image forming apparatus is applied, such as a direct transfer-type apparatus that directly transfers a toner image formed on a surface of an image holding member onto a recording medium; an intermediate transfer-type apparatus that primarily transfers a toner image formed on a surface of an image holding member onto a surface of an intermediate transfer member, and secondarily transfers the toner image transferred onto the surface of the intermediate transfer member onto a surface of a recording medium; or an apparatus that is provided with an erasing unit that irradiates, after transfer of a toner image and before charging, a surface of an image holding member with erasing light for erasing.

In the case of an intermediate transfer type apparatus, a transfer unit is configured to have, for example, an intermediate transfer member having a surface to which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to the exemplary embodiment, for example, a part including the developing unit may have a cartridge structure (process cartridge) that is detachable from the image forming apparatus. As the process cartridge, for example, a process cartridge that contains the electrostatic charge image developing developer according to the exemplary embodiment and is provided with a developing unit is suitably used.

Hereinafter, an example of the image forming apparatus according to the exemplary embodiment will be shown. However, the image forming apparatus is not limited thereto. Main portions shown in the drawing will be described, but descriptions of other portions will be omitted.

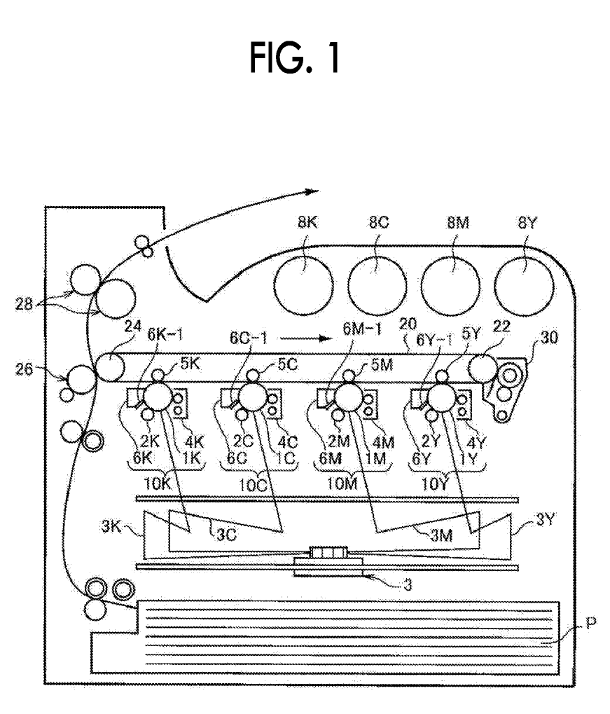

FIG. 1 is a schematic diagram showing a configuration of the image forming apparatus according to the exemplary embodiment.

The image forming apparatus shown in FIG. 1 is provided with first to fourth electrophotographic image forming units 10Y, 10M, 10C, and 10K (image forming units) that output yellow (Y), magenta (M), cyan (C), and black (K) images based on color-separated image data, respectively. These image forming units (hereinafter, may be simply referred to as “units”) 10Y, 10M, 10C, and 10K are arranged side by side at predetermined intervals in a horizontal direction. These units 10Y, 10M, 10C, and 10K may be process cartridges that are detachable from the image forming apparatus or a unit which may output a color other than the four colors described above may be added.

An intermediate transfer belt 20 as an intermediate transfer member is installed above the units 10Y, 10M, 10C, and 10K in the drawing to extend through the units. The intermediate transfer belt 20 is wound on a driving roll 22 and a support roll 24 contacting the inner surface of the intermediate transfer belt 20, which are disposed to be separated from each other on the left and right sides in the drawing, and travels in a direction toward the fourth unit 10K from the first unit 10Y. The support roll 24 is pressed in a direction in which it departs from the driving roll 22 by a spring or the like (not shown), and a tension is given to the intermediate transfer belt 20 wound on both of the rolls. In addition, an intermediate transfer member cleaning device 30 opposed to the driving roll 22 is provided on a surface of the intermediate transfer belt 20 on the image holding member side.

Developing devices (developing units) 4Y, 4M, 4C, and 4K of the units 10Y, 10M, 10C, and 10K are supplied with toner including four color toners, that is, a yellow toner, a magenta toner, a cyan toner, and a black toner contained in toner cartridges 8Y, 8M, 8C, and 8K, respectively.

The first to fourth units 10Y, 10M, 10C, and 10K have the same configuration, and accordingly, only the first unit 10Y that is disposed on the upstream side in a traveling direction of the intermediate transfer belt to form a yellow image will be representatively described here. The same parts as in the first unit 10Y will be denoted by the reference numerals with magenta (M), cyan (C), and black (K) added instead of yellow (Y), and descriptions of the second to fourth units 10M, 10C, and 10K will be omitted.

The first unit 10Y has a photoreceptor 1Y acting as an image holding member. Around the photoreceptor 1Y, a charging roll (an example of the charging unit) 2Y that charges a surface of the photoreceptor 1Y to a predetermined potential, an exposure device (an example of the electrostatic charge image forming unit) 3 that exposes the charged surface with laser beams 3Y based on a color-separated image signal to form an electrostatic charge image, a developing device (an example of the developing unit) 4Y that supplies a charged toner to the electrostatic charge image to develop the electrostatic charge image, a primary transfer roll (an example of the primary transfer unit) 5Y that transfers the developed toner image onto the intermediate transfer belt 20, and a photoreceptor cleaning device 6Y that includes a cleaning blade 6Y-1 that removes the toner remaining on the surface of the photoreceptor 1Y after primary transfer, are arranged in sequence.

The primary transfer roll 5Y is disposed inside the intermediate transfer belt 20 to be provided at a position opposed to the photoreceptor 1Y. Furthermore, bias supplies (not shown) that apply a primary transfer bias are connected to the primary transfer rolls 5Y, 5M, 5C, and 5K, respectively. Each bias supply changes a transfer bias that is applied to each primary transfer roll under the control of a controller (not shown).

Hereinafter, an operation of forming a yellow image in the first unit 10Y will be described.

First, before the operation, the surface of the photoreceptor 1Y is charged to a potential of −600 V to −800 V by the charging roll 2Y.

The photoreceptor 1Y is formed by laminating a photosensitive layer on a conductive substrate (for example, volume resistivity at 20° C.: 1×10⁻⁶ 52 cm or less). The photosensitive layer typically has high resistance (that is about the same as the resistance of a general resin), but has properties in which when laser beams 3Y are applied, the specific resistance of a part irradiated with the laser beams changes. Accordingly, the laser beams 3Y are output to the charged surface of the photoreceptor 1Y via the exposure device 3 in accordance with image data for yellow sent from the controller (not shown). The laser beams 3Y are applied to the photosensitive layer on the surface of the photoreceptor 1Y, so that an electrostatic charge image of a yellow image pattern is formed on the surface of the photoreceptor 1Y.

The electrostatic charge image is an image that is formed on the surface of the photoreceptor 1Y by charging, and is a so-called negative latent image, that is formed by applying laser beams 3Y to the photosensitive layer so that the specific resistance of the irradiated part is lowered to cause charges to flow on the surface of the photoreceptor 1Y, while charges stay on a part to which the laser beams 3Y are not applied.

The electrostatic charge image formed on the photoreceptor 1Y is rotated up to a predetermined developing position with the travelling of the photoreceptor 1Y. The electrostatic charge image on the photoreceptor 1Y is visualized (developed) as a toner image at the developing position by the developing device 4Y.

The developing device 4Y contains, for example, an electrostatic charge image developing developer including at least a yellow toner and a carrier. The yellow toner is frictionally charged by being stirred in the developing device 4Y to have a charge with the same polarity (negative polarity) as the charge that is on the photoreceptor 1Y, and is thus held on the developer roll (an example of the developer holding member). By allowing the surface of the photoreceptor 1Y to pass through the developing device 4Y, the yellow toner electrostatically adheres to the erased latent image part on the surface of the photoreceptor 1Y, so that the latent image is developed with the yellow toner. Next, the photoreceptor 1Y having the yellow toner image formed thereon continuously travels at a predetermined rate and the toner image developed on the photoreceptor 1Y is transported to a predetermined primary transfer position.

When the yellow toner image on the photoreceptor 1Y is transported to the primary transfer position, a primary transfer bias is applied to the primary transfer roll 5Y and an electrostatic force toward the primary transfer roll 5Y from the photoreceptor 1Y acts on the toner image, so that the toner image on the photoreceptor 1Y is transferred onto the intermediate transfer belt 20. The transfer bias applied at this time has the opposite polarity (+) to the toner polarity (−), and, for example, is controlled to +10 μA in the first unit 10Y by the controller (not shown).

On the other hand, the toner remaining on the photoreceptor 1Y is dammed up by an elastic blade (6Y-1) contacted with the photoreceptor at a suitable angle and is removed and collected by the photoreceptor cleaning device 6Y.

The primary transfer biases that are applied to the primary transfer rolls 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 100, and 10K, and the toner images of respective colors are multiply-transferred in a superimposed manner.

The intermediate transfer belt 20 onto which the four color toner images have been multiply-transferred through the first to fourth units reaches a secondary transfer part that is composed of the intermediate transfer belt 20, the support roll 24 contacting the inner surface of the intermediate transfer belt, and a secondary transfer roll (an example of the secondary transfer unit) 26 disposed on the image holding surface side of the intermediate transfer belt 20. Meanwhile, a recording sheet (an example of the recording medium) P is supplied to a gap between the secondary transfer roll 26 and the intermediate transfer belt 20, that are brought into contact with each other, via a supply mechanism at a predetermined timing, and a secondary transfer bias is applied to the support roll 24. The transfer bias applied at this time has the same polarity (−) as the toner polarity (−), and an electrostatic force toward the recording sheet P from the intermediate transfer belt 20 acts on the toner image, so that the toner image on the intermediate transfer belt 20 is transferred onto the recording sheet P. In this case, the secondary transfer bias is determined depending on the resistance detected by a resistance detector (not shown) that detects the resistance of the secondary transfer part, and is voltage-controlled.

Thereafter, the recording sheet P is fed to a pressure-contacting part (nip part) between a pair of fixing rolls in a fixing device (an example of the fixing unit) 28 so that the toner image is fixed to the recording sheet P, so that a fixed image is formed.

Examples of the recording sheet P onto which a toner image is transferred include plain paper that is used in electrophotographic copying machines, printers, and the like. As a recording medium, an OHP sheet is also exemplified other than the recording sheet P.

The surface of the recording sheet P is preferably smooth in order to further improve smoothness of the image surface after fixing. For example, coated paper obtained by coating a surface of plain paper with a resin or the like, art paper for printing, and the like are preferably used.

The recording sheet P on which the fixing of the color image is completed is discharged toward a discharge part, and a series of the color image forming operations ends.

Process Cartridge/Toner Cartridge

A process cartridge according to the exemplary embodiment will be described.

The process cartridge according to the exemplary embodiment is provided with a developing unit that contains the electrostatic charge image developing developer according to the exemplary embodiment and develops an electrostatic charge image formed on a surface of an image holding member with the electrostatic charge image developing developer to form a toner image, and is detachable from an image forming apparatus.

The process cartridge according to the exemplary embodiment is not limited to the above-described configuration, and may be configured to include a developing device, and if necessary, at least one selected from other units such as an image holding member, a charging unit, an electrostatic charge image forming unit, and a transfer unit.

Hereinafter, an example of the process cartridge according to the exemplary embodiment will be shown. However, the process cartridge is not limited thereto. Major parts shown in the drawing will be described, but descriptions of other parts will be omitted.

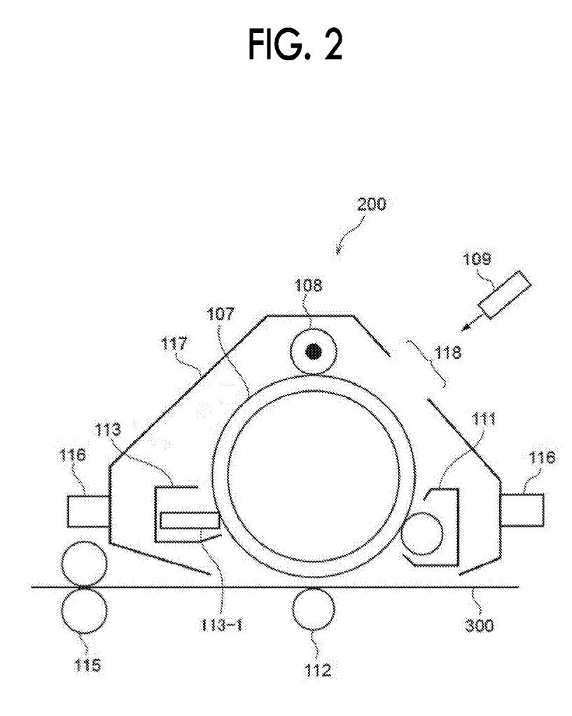

FIG. 2 is a schematic diagram showing a configuration of the process cartridge according to the exemplary embodiment.

A process cartridge 200 shown in FIG. 2 is formed as a cartridge having a configuration in which a photoreceptor 107 (an example of the image holding member), a charging roll 108 (an example of the charging unit), a developing device 111 (an example of the developing unit), and a photoreceptor cleaning device 113 including a cleaning blade 113-1 which are provided around the photoreceptor 107, are integrally combined and held by the use of, for example, a housing 117 provided with a mounting rail 116 and an opening 118 for exposure.

In FIG. 2, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to the exemplary embodiment will be described.

The toner cartridge according to the exemplary embodiment contains the toner according to the exemplary embodiment and is detachable from an image forming apparatus. The toner cartridge contains a toner for replenishment for being supplied to the developing unit provided in the image forming apparatus.

The image forming apparatus shown in FIG. 1 has such a configuration that the toner cartridges 8Y, 8M, 8C, and 8K are detachable therefrom, and the developing devices 4Y, 4M, 4C, and 4K are connected to the toner cartridges corresponding to the respective developing devices (colors) via toner supply tubes (not shown), respectively. In addition, in a case where the toner contained in the toner cartridge runs low, the toner cartridge is replaced.

### Examples

Hereinafter, the exemplary embodiment will be described in detail using examples but the exemplary embodiment is not limited to the examples. In the following description, parts” and “%” means “parts by weight” and “% by weight”, unless specifically noted.

Preparation of Colorant Particle Dispersion
Cyan pigment (C.I. PIGMENT BLUE 15:3 manufactured by Dainichiseika Color & Chemicals Mfg. Co., Ltd.): 21 parts
Ethyl acetate: 75 parts
DISPARLON DA-703-50 in which solvent is removed (polyester acid amidoamine salt manufactured by Kusumoto Chemicals, Ltd.): 3 parts
SOLSPERSE 5000 (manufactured by Zeneca K.K.): 1 parts

The above components are mixed with each other and dissolved and dispersed by using a sand mill, to obtain a colorant particle dispersion.

Preparation of Release Agent Particle Dispersion
Paraffin Wax (melting temperature of 90° C.): 30 parts
Ethyl acetate: 270 parts

The above components are subjected to wet pulverization by a micro beads dispersing machine (DCP mill) in a state of being cooled to 10° C. and a release agent particle dispersion is obtained.

Preparation of Toner Particles (1)

Preparation of Unmodified Polyester Resin
Ethylene oxide adduct of bisphenol A (BPA-EO): 181 parts
Propylene oxide adduct of bisphenol A (BPA-PO): 24 parts
Terephthalic acid: 211 parts

The monomers are put into a dried three-necked flask, the inside of which is substituted with N₂, the mixture is heated to 190° C. for dissolving while supplying N₂, and the mixture are sufficiently mixed with each other. After adding 0.1 parts of dibutyl tin oxide, the temperature in the system is increased to 225° C., and a reaction is performed while maintaining the temperature. During the reaction, a small amount of sample is collected to measure a molecular weight, and the reaction proceeding is controlled by adjusting the temperature or collecting moisture under the reduced pressure atmosphere, to obtain a desired condensate. Then, after decreasing the temperature to 180° C., 10 parts of phthalic anhydride is added and stirred under the reduced pressure atmosphere for 3 hours for reaction.

Preparation of Polyester Prepolymer
Ethylene oxide adduct of bisphenol A (BPA-EO): 183 parts
Propylene oxide adduct of bisphenol A (BPA-PO): 25 parts
Terephthalic acid: 9 parts
Isophthalic acid: 79 parts

The monomers are put into a dried three-necked flask, the inside of which is substituted with N₂, the mixture is heated to 190° C. for dissolving while supplying N₂, and the mixture are sufficiently mixed with each other. After adding 0.4 parts of dibutyl tin oxide, the temperature in the system is increased to 220° C., and a reaction is performed while maintaining the temperature. During the reaction, a small amount of sample is collected to measure a molecular weight, and the reaction proceeding is controlled by adjusting the temperature or collecting moisture under the reduced pressure atmosphere, to obtain a desired condensate.

350 parts of the obtained condensate, 25 parts of isophorone diisocyanate, and 450 parts of ethyl acetate are put in a vessel of another dried three-necked flask, the inside of which is substituted with N₂, the mixture is heated at 70° C. for 5 hours while supplying N₂, and a polyester prepolymer including an isocyanate group (hereinafter, “isocyanate-modified polyester prepolymer”) is obtained.

Preparation of Ketimine Compound
Methyl ethyl ketone: 20 parts
Isophorone diamine: 15 parts

The above materials are put into a vessel and stirred while increasing the temperature to 55° C., to obtain a ketimine compound.

Preparation of Oil-Phase Solution (1)
Colorant particle dispersion: 40 parts
Bentonite (manufactured by Wako Pure Chemical Industries, Ltd.): 5 parts
Ethyl acetate: 55 parts

The components are put, stirred and mixed with each other sufficiently. 135 parts of the unmodified polyester resin and 75 parts of the release agent particle dispersion are added to the obtained mixed solution and sufficiently stirred to prepare an oil-phase solution (1).

Preparation of Styrene Acrylic Resin Particle Dispersion (1)
Styrene: 85 parts
n-Butyl acrylate: 90 parts
Methacrylic acid: 85 parts
Polyoxyalkylene sulfate methacrylate Na (ELEMINOL RS-30 manufactured by Sanyo Chemical Industries, Ltd.): 10 parts
Dodecanethiol: 5 parts

The components are put into reaction vessel capable of circulating and stirred and mixed with each other sufficiently. 650 parts of ion exchange water and 1 part of ammonium persulfate are rapidly put into the mixture and dispersed and emulsified by using a homogenizer (ULTRA TURRAX T50 manufactured by IKA Works, Inc.) while maintaining a temperature equal to or lower than room temperature, to obtain white emulsion. The temperature in the system is increased to 75° C. while stirring the mixture while supplying N₂, and emulsion polymerization is continued for 5 hours. 20 parts of 1% ammonium persulfate aqueous solution is slowly added dropwise and maintained at 75° C. for 2 hours to complete the polymerization. Accordingly, a dispersion (1) containing the styrene acrylic resin particles is obtained. When the styrene acrylic resin particles are observed with an electron microscope, a volume average particle diameter D50v of the styrene acrylic resin particles is 120 nm.

Preparation of Water-Phase Solution (1)
Styrene acrylic resin particle dispersion (1): 60 parts
2% aqueous solution of SEROGEN BS-H (CMC manufactured by DKS Co., Ltd.): 210 parts
Anionic surfactant (DOWFAX2A1 manufactured by The Dow Chemical Company): 4 parts
Ion exchange water: 190 parts

The above components are stirred and mixed with each other sufficiently to obtain a water-phase solution (1).

Preparation of Toner Particles (1)
Oil-phase solution (1): 350 parts
Isocyanate-modified polyester prepolymer: 30 parts
Ketimine compound: 10 parts

After putting the above components in a round-bottomed stainless steel flask and stirring the components using a homogenizer (ULTRA TURRAX manufactured by IKA Works, Inc.) for 2 minutes to prepare a mixed oil-phase solution, 900 parts of water-phase solution (1) is added to the same flask and rapidly forcibly emulsified using a homogenizer (8,000 rpm) for approximately 1 minute. Then, the emulsion is stirred using a paddle-type stirrer at a temperature equal to or lower than room temperature under the normal pressure (1 atmospheric pressure) for approximately 15 minutes, to proceed particle formation and urea modification reaction of the polyester resin. After that, after distilling the solvent under the reduced pressure, the urea modification reaction is completed by stirring the mixture at 80° C. for 7 hours while further removing the solvent under the normal pressure.

After cooling to room temperature, the suspension of the formed particles is taken out and sufficiently cleaned with ion exchange water, and solid-liquid separation is performed by Nutsche-type suction filtration. Then, the content is dispersed again in ion exchange water at 40° C. and cleaned while being stirred for 15 minutes. After repeating the cleaning operation several times, solid-liquid separation is performed by Nutsche-type suction filtration and freeze drying is performed under the vacuum state to obtain toner particles (1).

A volume average particle diameter D50 v of the toner particles (1) is 5.6 μm.

Preparation of Toner Particles (2)

Preparation of Oil-Phase Solution (2)
Polyester resin (1): 130 parts
Colorant particle dispersion: 30 parts
Release agent particle dispersion: 70 parts
Ethyl acetate: 60 parts

The above components are put into a flask and stirred and mixed with each other sufficiently at room temperature.

Preparation of Water-Phase Solution (2)
Calcium carbonate dispersion: 130 parts (a material obtained by sufficiently mixing 52 parts of calcium carbonate and 78 parts of ion exchange water)
2% aqueous solution of SEROGEN BS-H (manufactured by DKS Co., Ltd.): 105 parts
Ion exchange water: 170 parts

The above components are put into a stainless steel flask and stirred with a homogenizer (ULTRA TURRAX manufactured by IKA Works, Inc.) for 10 minutes.

The oil-phase solution (2) is slowly put into and sufficiently dispersed in the water-phase solution (2) which is being stirred with a homogenizer (ULTRA TURRAX manufactured by IKA Works, Inc.) to obtain a suspension. The suspension is stirred using a propeller-attached stirrer under release-type atmosphere at room temperature under normal pressure, to remove the organic solvent. Dilute hydrochloric acid is slowly added to the mixed solution and the calcium carbonate component is dissolved and removed from the surface of the suspended particles. Then, the filtering for removing coarse powder and washing with ion exchange water are performed, and solid-liquid separation is performed by Nutsche-type suction filtration. In addition, the solid content is dispersed again in 3 liters of ion exchange water at 30° C., and stirred for 15 minutes and washed. The washing operation is repeated and solid-liquid separation is performed again. Then, freeze drying is performed under the vacuum state and toner particles (2) are obtained.

A volume average particle diameter D50v of the toner particles (2) is 6.5 μm.

Properties of Toner Particles

Hereinafter, details of the toner particles (1) and (2) are collectively shown in Table 1. The volume average particle diameter (D50v) of the obtained toner particles is measured by the method described above. When the surface of the toner particles is observed by SEM observation, the vinyl resin particles are gently fused with each other in the vicinity of the surface of the toner particles (1).

TABLE 1

| | | | Volume | | Particle |
|---|---|---|---|---|---|
| | Preparing | | average | | diameter of |
| Toner | method of | Urea- | particle | Vinyl | vinyl resin |
| parti- | toner | modifi- | diameter | resin | particles |
| cles | particles | cation | (μm) | particles | (nm) |
| (1) | Ester | Performed | 5.6 | Used | 120 |
| | extension | | | | (embedded in |
| | method | | | | boundaries |
| | | | | | of toner) |
| (2) | Dissolution | Not | 6.5 | Not | — |
| | and suspension | performed | | used | |
| | method | | | | |

Preparation of External Additive

Preparation of silica particle dispersion (1) 300 parts of methanol and 70 parts of 10% ammonia water are added and mixed with each other in a 1.5-L glass reaction vessel including a stirrer, dripping nozzles, and a thermometer to obtain an alkali catalyst solution.

After adjusting the temperature of the alkali catalyst solution to 30° C., 185 parts of tetramethoxysilane (noted as TMOS) and 50 parts of 8.0% ammonia water are added dropwise at the same time while stirring the mixture, and a hydrophilic silica particle dispersion (solid content concentration of 12.0% by weight) is obtained. Here, dropping time is 30 minutes.

After that, the obtained silica particle dispersion is concentrated using ROTARY FILTER R-FINE (manufactured by Kotobuki Kogyou Co., Ltd.) to have solid content concentration of 40% by weight. The concentrated material is set as a silica particle dispersion (1).

Preparation of Silica Particle Dispersion (2) to (7)

Silica particle dispersion (2) to (7) are prepared in the same manner as in the silica particle dispersion (1), except for changing preparation conditions of the alkali catalyst solution (methanol amount and 10% ammonia water amount) and silica particles (total amount added dropwise and dropping time of tetramethoxysilane (noted as TMOS) and 8% ammonia water to alkali catalyst solution) in the preparation of the silica particle dispersion (1), according to Table 2.

Hereinafter, details of the silica particle dispersions (1) to (7) are collectively shown in Table 2.

TABLE 2

| | | | Silica particle | | |
|---|---|---|---|---|---|
| | Alkali catalyst | | preparation conditions | | |
| | solution | | TMOS | 8% ammonia | |
| Silica | | 10% | total | water total | |
| particle | | ammonia | dropping | dropping | |
| disper- | Methanol | water | amount | amount holder | Dropping |
| sion | (part) | (part) | (part) | (part) | time |
| (1) | 300 | 70 | 185 | 50 | 30 min |
| (2) | 300 | 70 | 340 | 92 | 55 min |
| (3) | 300 | 46 | 40 | 25 | 30 min |
| (4) | 300 | 70 | 62 | 17 | 10 min |
| (5) | 300 | 70 | 700 | 200 | 120 min |
| (6) | 300 | 70 | 500 | 140 | 85 min |
| (7) | 300 | 70 | 1000 | 280 | 170 min |

Preparation of Surface-Treated Silica Particles (S1)

The surface treatment of the silica particles with a siloxane compound is performed under the supercritical carbon dioxide atmosphere by using the silica particle dispersion (1) as follows. In the surface treatment, a device including a carbon dioxide cylinder, a carbon dioxide pump, an entrainer pump, a stirrer-attached autoclave (volume of 500 ml), and a pressure valve is used.

First, 250 parts of the silica particle dispersion (1) is put into the stirrer-attached autoclave (volume of 500 ml), and the stirrer is rotated at 100 rpm. Then, liquid carbon dioxide is injected into the autoclave, pressure is increased by using the carbon dioxide pump while increasing the temperature using a heater, and the atmosphere in the autoclave is set as a supercritical state at 150° C. and 15 MPa. The supercritical carbon dioxide is circulated using the carbon dioxde pump while maintaining the pressure in the autoclave at 15 MPa with the pressure valve, and methanol and water are removed from the silica particle dispersion (1) (solvent removing process), to obtain silica particles (unprocessed silica particles).

Next, the circulating of supercritical carbon dioxide is stopped, when the circulating amount of the circulated supercritical carbon dioxide (integrated quantity: measured as circulating amount of carbon dioxide in a standard condition) becomes 900 parts.

After that, in a state where the temperature of 150° C. is maintained by the heater, the pressure of 15 MPa is maintained by the carbon dioxide pump, and the supercritical state of carbon dioxide is maintained in the autoclave, a processing agent solution obtained by dissolving 0.3 parts of dimethyl silicone oil (DSO: product name “KF-96 (Shin-Etsu Chemical Co., Ltd.)”) having viscosity of 10,000 cSt as a siloxane compound in 20 parts of hexamethyldisilazane (HMDS manufactured by Yuki Gosei Kogyo Co., Ltd.) as a hydrophobizing agent, in advance, with respect to 100 parts of the silica particles (unprocessed silica particles), is injected into the autoclave using the entrainer pump, and reacted at 180° C. for 20 minutes, while stirring. After that, supercritical carbon dioxide is circulated again to remove excess processing agent solution. Then, the stirring is stopped, the pressure valve is opened to release the pressure in the autoclave to the atmosphere pressure, and the temperature is decreased to room temperature (25° C.)

As described above, the solvent removing process and the surface treatment with the siloxane compound are sequentially performed and surface-treated silica particles (S1) are obtained.

Preparation of Surface-Treated Silica Particles (S2) to (S5), (S7) to (S9), and (S12) to (S17)

Surface-treated silica particles (S2) to (S5), (S7) to (S9), and (S12) to (S17) are prepared in the same manner as in the surface-treated silica particles (S1), except for changing the silica particle dispersion and surface treatment conditions (processing atmosphere, siloxane compound (type, viscosity, and amount added), hydrophobizing agent and the amount added) in the preparation of the surface-treated silica particles (S1), according to Table 3.

Preparation of Surface-Treated Silica Particles (S6)

The surface treatment of the silica particles with a siloxane compound is performed under the atmosphere, as follows, using the same dispersion as the silica particle dispersion (1) used in the preparation of the surface-treated silica particles (S1).

An ester adapter and a cooling tube are attached to the reaction vessel used in the preparation of the silica particle dispersion (1), water is added when the silica particle dispersion (1) is heated to 60° C. to 70° C. and methanol is distilled, and the silica particle dispersion is further heated to 70° C. to 90° C. to distil methanol, and aqueous dispersion of silica particles is obtained. 3 parts of methyltrimethoxysilane (MTMS manufactured by Shin-Etsu Chemical Co., Ltd.) is added to 100 parts of silica solid content in the aqueous dispersion at room temperature, and a reaction is caused for 2 hours to perform the treatment of the silica particle surface. After adding methyl isobutyl ketone to the surface-treated dispersion, the mixture is heated to 80° C. to 110° C. to distill methanol, 80 parts of hexamethyldisilazane (HMDS manufactured by Yuki Gosei Kogyo Co., Ltd.) and 1.0 part of dimethyl silicone oil (DSO: product name “KF-96 (Shin-Etsu Chemical Co., Ltd.)”) having viscosity of 10,000 cSt as a siloxane compound are added to 100 parts of the silica solid content in the obtained dispersion at room temperature, reacted at 120° C. for 3 hours, cooled, and dried by spray drying, and surface-treated silica particles (S6) are obtained.

Preparation of Surface-Treated Silica Particles (S10)

Surface-treated silica particles (S10) are prepared in the same manner as in the surface-treated silica particles (S1), except for using FUMED SILICA OX50 (AEROSIL OX50 manufactured by Nippon Aerosil co. Ltd.), instead of the silica particle dispersion (1). That is, 100 parts of OX50 is put into the same stirrer-attached autoclave as in the preparation of the surface-treated silica particles (S1), and the stirrer is rotated at 100 rpm. Then, liquid carbon dioxide is injected into the autoclave, pressure is increased by using the carbon dioxide pump while increasing the temperature using a heater, and the atmosphere in the autoclave is set as a supercritical state at 180° C. and 15 MPa. While maintaining the pressure in the autoclave at 15 MPa using the pressure valve, a processing agent solution obtained by dissolving 0.3 parts of dimethyl silicone oil (DSO: product name “KF-96 (Shin-Etsu Chemical Co., Ltd.)”) having viscosity of 10,000 cSt as a siloxane compound in 20 parts of hexamethyldisilazane (HMDS manufactured by Yuki Gosei Kogyo Co., Ltd.) as a hydrophobizing agent, in advance, is injected into the autoclave using the entrainer pump, stirred, and reacted at 180° C. for 20 minutes. Then, supercritical carbon dioxide is circulated to remove excess processing agent solution, and surface-treated silica particles (S10) are obtained.

Preparation of Surface-Treated Silica Particles (S11)

Surface-treated silica particles (S11) are prepared in the same manner as in the surface-treated silica particles (S1), except for using FUMED SILICA A50 (AEROSIL A50 manufactured by Nippon Aerosil co. Ltd.), instead of the silica particle dispersion (1). That is, 100 parts of A50 is put into the same stirrer-attached autoclave as in the preparation of the surface-treated silica particles (S1), and the stirrer is rotated at 100 rpm. Then, liquid carbon dioxide is injected into the autoclave, pressure is increased by using the carbon dioxide pump while increasing the temperature using a heater, and the atmosphere in the autoclave is set as a supercritical state at 180° C. and 15 MPa. While maintaining the pressure in the autoclave at 15 MPa using the pressure valve, a processing agent solution obtained by dissolving 1.0 part of dimethyl silicone oil (manufactured by Shin-Etsu Chemical Co., Ltd.) having viscosity of 10,000 cSt as a siloxane compound in 20 parts of hexamethyldisilazane (HMDS manufactured by Yuki Gosei Kogyo Co., Ltd.) as a hydrophobizing agent, in advance, is injected into the autoclave using the entrainer pump, stirred, and reacted at 180° C. for 20 minutes. Then, supercritical carbon dioxide is circulated to remove excess processing agent solution, and surface-treated silica particles (S11) are obtained.

Preparation of Surface-Treated Silica Particles (SC1)

Surface-treated silica particles (SC1) are prepared in the same manner as in the surface-treated silica particles (S1), except for not adding the siloxane compound in the preparation of the surface-treated silica particles (S1).

Preparation of Surface-Treated Silica Particles (SC2) to (SC4)

Surface-treated silica particles (SC2) to (SC4) are prepared in the same manner as in the surface-treated silica particles (S1), except for changing the silica particle dispersion and surface treatment conditions (processing atmosphere, siloxane compound (type, viscosity, and amount added), hydrophobizing agent and the amount added) in the preparation of the surface-treated silica particles (S1), according to Table 4.

Preparation of Surface-Treated Silica Particles (SC5)

Surface-treated silica particles (SC5) are prepared in the same manner as in the surface-treated silica particles (S6), except for not adding the siloxane compound in the preparation of the surface-treated silica particles (S6).

Preparation of Surface-Treated Silica Particles (SC6)

Surface-treated silica particles (SC6) are prepared by filtering and drying the silica particle dispersion (8) at 120° C., putting the silica particle dispersion into an electrical furnace to perform sintering at 400° C. for 6 hours, and spraying and drying 10 parts of HMDS with respect to 100 parts of silica by spray drying.

Properties of Surface-Treated Silica Particles

Regarding the obtained surface-treated silica particles, an average equivalent circle diameter, an average circularity, the amount of siloxane compound attached to the unprocessed silica particles (noted as “surface attachment amount” in the table”), a compression aggregation degree, a particle compression ratio, and a particle dispersion degree are measured by the methods described above.

Hereinafter, details of the surface-treated silica particles are shown as a list in Tables 3 to 4. The abbreviations in Tables 3 to 4 are as follows.

DSO: dimethyl silicone oil

HMDS: hexamethyldisilazane

TABLE 3

| | | Surface treatment conditions | | | | |
|---|---|---|---|---|---|---|
| | | Siloxane compound | | | | |
| Surface-treated | Silica particles | | Viscosity | Additive | Treatment | Hydrophobizing |
| silica particles | dispersion | Type | (cSt) | amount (part) | atmosphere | agent/part |
| (S1) | (1) | DSO | 10000 | 0.3 parts | Supercritical CO₂ | HMDS/20 parts |
| (S2) | (1) | DSO | 10000 | 1.0 parts | Supercritical CO₂ | HMDS/20 parts |
| (S3) | (1) | DSO | 5000 | 0.15 parts | Supercritical CO₂ | HMDS/20 parts |
| (S4) | (1) | DSO | 5000 | 0.5 parts | Supercritical CO₂ | HMDS/20 parts |
| (S5) | (2) | DSO | 10000 | 0.2 parts | Supercritical CO₂ | HMDS/20 parts |
| (S6) | (1) | DSO | 10000 | 1.0 parts | Atmosphere | HMDS/80 parts |
| (S7) | (3) | DSO | 10000 | 0.3 parts | Supercritical CO₂ | HMDS/20 parts |
| (S8) | (4) | DSO | 10000 | 0.3 parts | Supercritical CO₂ | HMDS/20 parts |
| (S9) | (1) | DSO | 50000 | 1.5 parts | Supercritical CO₂ | HMDS/20 parts |
| (S10) | FUMED SILICA | DSO | 10000 | 0.3 parts | Supercritical CO₂ | HMDS/20 parts |
| | OX50 | | | | | |
| (S11) | FUMED SILICA | DSO | 10000 | 1.0 parts | Supercritical CO₂ | HMDS/40 parts |
| | A50 | | | | | |
| (S12) | (3) | DSO | 5000 | 0.04 parts | Supercritical CO₂ | HMDS/20 parts |
| (S13) | (3) | DSO | 1000 | 0.5 parts | Supercritical CO₂ | HMDS/20 parts |
| (S14) | (3) | DSO | 10000 | 5.0 parts | Supercritical CO₂ | HMDS/20 parts |
| (S15) | (5) | DSO | 10000 | 0.5 parts | Supercritical CO₂ | HMDS/20 parts |
| (S16) | (6) | DSO | 10000 | 0.5 parts | Supercritical CO₂ | HMDS/20 parts |
| (S17) | (7) | DSO | 10000 | 0.5 parts | Supercritical CO₂ | HMDS/20 parts |

| | Properties of surface treated silica particles | | | | | |
|---|---|---|---|---|---|---|
| | | | Surface | | | |
| | Average equivalent | | attachment | Compression | Particle | Particle |
| Surface-treated | circle diameter | Average | amount (% | aggregation | compression | dispersion |
| silica particles | (nm) | circularity | by weight) | degree (%) | ratio | degree (%) |
| (S1) | 120 | 0.958 | 0.28 | 85 | 0.310 | 98 |
| (S2) | 120 | 0.958 | 0.98 | 92 | 0.280 | 97 |
| (S3) | 120 | 0.958 | 0.12 | 80 | 0.320 | 99 |
| (S4) | 120 | 0.958 | 0.47 | 88 | 0.295 | 98 |
| (S5) | 140 | 0.962 | 0.19 | 81 | 0.350 | 99 |
| (S6) | 120 | 0.958 | 0.50 | 83 | 0.380 | 93 |
| (S7) | 130 | 0.850 | 0.29 | 68 | 0.360 | 92 |
| (S8) | 90 | 0.935 | 0.29 | 94 | 0.390 | 95 |
| (S9) | 120 | 0.958 | 1.25 | 95 | 0.240 | 91 |
| (S10) | 80 | 0.880 | 0.26 | 84 | 0.395 | 92 |
| (S11) | 45 | 0.880 | 0.91 | 88 | 0.276 | 91 |
| (S12) | 130 | 0.850 | 0.02 | 62 | 0.360 | 96 |
| (S13) | 130 | 0.850 | 0.46 | 90 | 0.380 | 92 |
| (S14) | 130 | 0.850 | 4.70 | 95 | 0.360 | 91 |
| (S15) | 185 | 0.971 | 0.43 | 61 | 0.209 | 96 |
| (S16) | 164 | 0.97 | 0.41 | 64 | 0.224 | 97 |
| (S17) | 210 | 0.978 | 0.44 | 60 | 0.205 | 98 |

TABLE 4

| | | Surface treatment conditions | | | | |
|---|---|---|---|---|---|---|
| | | Siloxane compound | | | | |
| Surface-treated | Silica particle | | Viscosity | Additive | Treatment | Hydrophobizing |
| silica particles | dispersion | Type | (cSt) | amount (part) | atmosphere | agent/part |
| (SC1) | (1) | — | — | — | Supercritical CO₂ | HMDS/20 parts |
| (SC2) | (1) | DSO | 100 | 3.0 parts | Supercritical CO₂ | HMDS/20 parts |
| (SC3) | (1) | DSO | 1000 | 8.0 parts | Supercritical CO₂ | HMDS/20 parts |
| (SC4) | (3) | DSO | 3000 | 10.0 parts | Supercritical CO₂ | HMDS/20 parts |
| (SC5) | (1) | — | — | — | Atmosphere | HMDS/80 parts |
| (SC6) | (8) | — | — | — | Atmosphere | HMDS/10 parts |

| | Properties of surface treated silica particles | | | | | |
|---|---|---|---|---|---|---|
| | | | Surface | | | |
| | Average equivalent | | Attachment | Compression | Particle | Particle |
| Surface-treated | circle diameter | Average | amount (% | aggregation | compression | dispersion |
| silica particles | (nm) | circularity | by weight) | degree (%) | ratio | degree (%) |
| (SC1) | 120 | 0.958 | — | 55 | 0.415 | 99 |
| (SC2) | 120 | 0.958 | 2.5 | 98 | 0.450 | 75 |
| (SC3) | 120 | 0.958 | 7.0 | 99 | 0.360 | 83 |
| (SC4) | 130 | 0.850 | 8.5 | 99 | 0.380 | 85 |
| (SC5) | 120 | 0.958 | — | 82 | 0.425 | 98 |
| (SC6) | 300 | 0.980 | — | 60 | 0.197 | 93 |

### Examples 1 to 17 and Comparative Examples 1 to 7

1.5 parts of silica particles shown in Table 5 is added to 100 parts of toner particles shown in Table 5 and mixed with each other with a HENSCHEL MIXER at 2,000 rpm for 3 minutes, and a toner of each example is obtained.

The obtained toner and a carrier are put into a V blender at a ratio of toner:carrier=5:95 (weight ratio), and stirred for 20 minutes, to obtain each developer.

As the carrier, a carrier prepared as described below is used.
Ferrite particles (average particle diameter of 50 μm): 100 parts
Toluene: 14 parts
A styrene-methyl methacrylate copolymer: 2 parts (component ratio: 90/10, Mw=80,000)
Carbon black (R330 manufactured by Cabot Corporation): 0.2 parts

First, the above components excluding the ferrite particles are stirred by a stirrer for 10 minutes to prepare a dispersed coating solution, the coating solution and the ferrite particles are put into a vacuum degassing type kneader, stirred at 60° C. for 30 minutes, degassed under the reduced pressure while heating, and dried to obtain a carrier.

Evaluation

Regarding developers obtained in each example, the filming on a surface of a photoreceptor is evaluated. The results thereof are shown in Table 5.

Filming on Surface of Photoreceptor

A developing device of an image forming apparatus “APEOSPORT IV-05570 remodeled device” is filled with the developer obtained in each example. 20,000 sheets of a pattern image having image density of 5% are printed on A4-si zed sheets using the image forming apparatus, under the environment of a temperature of 22° C. and humidity of 55 RH. During the operation, the surface of the photoreceptor is observed with a laser microscope, in each state after the printing of 5,000 sheets, after the printing of 10,000 sheets, and after the printing of 20,000 sheets, and the streak-shaped filming on the surface of the photoreceptor (the ratio of the area of the streak-shaped filming to the area of the surface of the photoreceptor) is evaluated with the following criteria. The evaluation of the sample having excessive filming state is stopped during the evaluation.

A: the area ratio is equal to or smaller than 5% (excellent)

B: the area ratio is greater than 5% and equal to or smaller than 10% (sufficient to be used)

C: the area ratio is greater than 10% and equal to or smaller than 20% (effects on some images but acceptable)

D: the area ratio is greater than 20% (image defects observed)

Charging Stability Evaluation

A developing device of an image forming apparatus “APEOSPORT IV-05570” is filled with the developer obtained in each example. First, the developer in the developing device is circulated and mixed by operating an off-line jig which transmits power to a rotation portion (magnetic roll or the like) of the developing device for 1 minute, under the conditions of the temperature of 28° C. and humidity of 85% RH (environment A) and conditions of the temperature of 10° C. and humidity of 15% RH (environment C), and a small amount of the developer on the magnetic roll is collected. After further operating the jig for 9 minutes, a sample is collected in the same manner. The measurement of the collected developer is performed using a blow-off charge amount measuring device (TB-200 manufactured by Toshiba Chemical Corporation).

The charging stability is evaluated with the following evaluation criteria based on the following equation.

fluctuation of charging amount (%)=(1−(charging amount of collection after operation for 10 minutes/charging amount after operation for 1 minute))×100 Equation:

Evaluation Criteria are as Follows.

A: a case where the fluctuation of charging amount measured taking the toner concentration into account is equal to or smaller than ±10% under both environments A and C

B: a case where the fluctuation of charging amount measured taking the toner concentration into account is equal to or smaller than ±10% under one environment, but fluctuation thereof is greater than ±10% and equal to or smaller than ±20% under the other environment

C: a case where the fluctuation of charging amount measured taking the toner concentration into account is greater than ±10% and equal to or smaller than ±20% under both environments A and C

D: a case where the fluctuation of charging amount measured taking the toner concentration into account is greater than ±20% under any one of environment

TABLE 5

| | | | | | | Filming | | |
|---|---|---|---|---|---|---|---|---|
| | Toner particles | | | | | After | After | After |
| | | Ester | | Silica | Charging | printing | printing | printing |
| | | extension | Vinyl resin | particles | stability | 5000 | 10000 | 20000 |
| | Type | polyester | particles | Type | Determination | sheets | sheets | sheets |
| Example 1 | (1) | Present | Present | (S1) | A | A | A | A |
| Example 2 | (1) | Present | Present | (S2) | A | A | A | A |
| Example 3 | (1) | Present | Present | (S3) | A | A | A | A |
| Example 4 | (1) | Present | Present | (S4) | A | A | A | A |
| Example 5 | (1) | Present | Present | (S5) | A | A | A | A |
| Example 6 | (1) | Present | Present | (S6) | C | A | B | C |
| Example 7 | (1) | Present | Present | (S7) | A | A | A | B |
| Example 8 | (1) | Present | Present | (S8) | B | A | B | C |
| Example 9 | (1) | Present | Present | (S9) | B | A | A | A |
| Example 10 | (1) | Present | Present | (S10) | C | B | B | C |
| Example 11 | (1) | Present | Present | (S11) | C | B | B | C |
| Example 12 | (1) | Present | Present | (S12) | B | A | A | A |
| Example 13 | (1) | Present | Present | (S13) | A | A | A | B |
| Example 14 | (1) | Present | Present | (S14) | B | A | A | A |
| Example 15 | (1) | Present | Present | (S15) | B | A | B | B |
| Example 16 | (1) | Present | Present | (S16) | A | A | B | B |
| Example 17 | (1) | Present | Present | (S17) | B | A | B | C |
| Comparative | (1) | Present | Present | (SC1) | D | C | D | — |
| Example 1 | | | | | | | | |
| Comparative | (1) | Present | Present | (SC2) | C | B | C | D |
| Example 2 | | | | | | | | |
| Comparative | (1) | Present | Present | (SC3) | C | B | D | — |
| Example 3 | | | | | | | | |
| Comparative | (1) | Present | Present | (SC4) | D | C | C | D |
| Example 4 | | | | | | | | |
| Comparative | (1) | Present | Present | (SC5) | D | C | D | — |
| Example 5 | | | | | | | | |
| Comparative | (1) | Present | Present | (SC6) | D | C | D | — |
| Example 6 | | | | | | | | |
| Comparative | (2) | Absent | Absent | (S1) | B | A | C | D |
| Example 7 | | | | | | | | |

From the results described above, it is found that, in the examples, occurrence of streak-filming on the surface of the photoreceptor is prevented, compared to the comparative examples.

Particularly, it is found that, in Examples 1, 2, 3, 4, and 5 in which silica particles having the compression aggregation degree of 70% to 95% and the particle compression ratio of 0.28 to 0.36 are used as external additive, occurrence of streak-filming on the surface of the photoreceptor is prevented, compared to other examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding member;
a charging unit that charges a surface of the image holding member;
an electrostatic charge image forming unit that forms an electrostatic charge image on a charged surface of the image holding member;
a developing unit that contains an electrostatic charge image developer and develops the electrostatic charge image formed on the surface of the image holding member with the electrostatic charge image developer as a toner image;
a transfer unit that transfers the toner image formed on the surface of the image holding member onto a surface of a recording medium;
a cleaning unit that includes a cleaning blade that cleans the surface of the image holding member; and
a fixing unit that fixes the toner image transferred onto the surface of the recording medium,
wherein the electrostatic charge image developer contains a carrier and
an electrostatic charge image developing toner that includes a toner particle which contains a urea-modified polyester resin, and includes, in a vicinity of a surface thereof, vinyl resin particles; and an external additive which contains silica particles having a compression aggregation degree of 60% to 95% and a particle compression ratio of 0.20 to 0.40.

2. The image forming apparatus according to claim 1,
wherein an average equivalent circle diameter of the silica particles is from 40 nm to 200 nm.

3. The image forming apparatus according to claim 1,
wherein a particle dispersion degree of the silica particles is from 90% to 100%.

4. The image forming apparatus according to claim 1,
wherein the silica particles are surface-treated with a siloxane compound having a viscosity of 1,000 cSt to 50,000 cSt and a surface attachment amount of the siloxane compound is from 0.01% by weight to 5% by weight.

5. The image forming apparatus according to claim 4,
wherein the siloxane compound is silicone oil.

6. An electrostatic charge image developer which is used for an image forming apparatus, comprising:
a carrier; and
an electrostatic charge image developing toner that includes a toner particle which contains a urea-modified polyester resin and includes, in a vicinity of a surface thereof, vinyl resin particles, and an external additive which contains silica particles having a compression aggregation degree of 60% to 95% and a particle compression ratio of 0.20 to 0.40.

7. An electrostatic charge image developing toner which is used for an image forming apparatus, comprising:
a toner particle that contains a urea-modified polyester resin and includes, in a vicinity of a surface thereof, vinyl resin particles; and an external additive which contains silica particles having a compression aggregation degree of 60% to 95% and a particle compression ratio of 0.20 to 0.40.
